(19) United States
(12) Patent Application Publication
(10) Pub. No.: US 2026/0208971 A1
(43) Pub. Date: Jul. 23, 2026

(54) CONVEYING DEVICE AND MEDICATION SUPPORT APPARATUS

(71) Applicants: Manabu Yamanaka, Aichi (JP); Yoshihide Sugiyama, Gifu (JP); Terumitsu Azuma, Chiba (JP); Hiroshi Fujie, Aichi (JP); Takato Mochizuki, Kanagawa (JP); Takumi Hagiwara, Aichi (JP); Youhei Niitsuma, Kanagawa (JP); Yu Yamaya, Gifu (JP); Sachika Tashiro, Kanagawa (JP); Hirotaka Hayashi, Aichi (JP)

(72) Inventors: Manabu Yamanaka, Aichi (JP); Yoshihide Sugiyama, Gifu (JP); Terumitsu Azuma, Chiba (JP); Hiroshi Fujie, Aichi (JP); Takato Mochizuki, Kanagawa (JP); Takumi Hagiwara, Aichi (JP); Youhei Niitsuma, Kanagawa (JP); Yu Yamaya, Gifu (JP); Sachika Tashiro, Kanagawa (JP); Hirotaka Hayashi, Aichi (JP)

(73) Assignee: ETRIA Co., Ltd., Kanagawa (JP)

(21) Appl. No.: 19/418,959

(22) Filed: Dec. 13, 2025

(30) Foreign Application Priority Data
Jan. 17, 2025 (JP) 2025-007247

(51) Int. Cl. B65G 47/34; A61J 7/00; B65G 47/24; B65G 47/90

(52) U.S. Cl. CPC B65G 47/34; A61J 7/0069; A61J 7/0076; B65G 47/24; B65G 47/90; B65G 2201/0258

(57) ABSTRACT

A conveying device includes a holder to pick up a medicine pack from a container and hold the medicine pack, a conveyor to convey the medicine pack held by the holder, and a changer to change a position or orientation of the medicine pack held by the holder, on a movement path of the conveyor.

### CROSS-REFERENCE TO RELATED APPLICATION

This patent application is based on and claims priority pursuant to 35 U.S.C. § 119(a) to Japanese Patent Application No. 2025-007247, filed on Jan. 17, 2025, in the Japan Patent Office, the entire disclosure of which is hereby incorporated by reference herein.

### BACKGROUND

### Technical Field

The present disclosure relates to a conveying device and a medication support apparatus.

### Background Art

Conveying devices have been proposed that are provided with a holder to pick up a medicine pack from a container that stores a plurality of medicine packs and hold the picked-up medicine pack, and a conveyance unit or conveying device that conveys the medicine pack held by the holder. For example, medicine sheets such as medicine packs inside a medicine-sheet container are sucked up, held, and picked up by a suction device or the holder.

### SUMMARY

The present disclosure described herein provides a conveying device and a medication support apparatus. The conveying device includes a holder to pick up a medicine pack from a container and hold the medicine pack, a conveyor to convey the medicine pack held by the holder, and a changer to change a position or orientation of the medicine pack held by the holder, on a movement path of the conveyor. In the medication support apparatus, a medicine pack stored in a container is dispensed to a desired position of a medicine tray by the conveying device.

### BRIEF DESCRIPTION OF THE DRAWINGS

A more complete appreciation of embodiments and the many attendant advantages thereof will be readily obtained as the same becomes better understood by reference to the following detailed description when considered in connection with the accompanying drawings.

FIG. 1A is a front view of a medication support apparatus in its entirety.

FIG. 1B is a side view of the medication support apparatus of FIG. 1A.

FIG. 2A is a typical plan view of a single medicine package.

FIG. 2B a side view of the single medicine package of FIG. 2A viewed in a direction indicated by an arrow A.

FIG. 2C is a side view of bound medicine packages viewed in a direction indicated by an arrow B.

FIG. 2D is a diagram illustrating a typical form of continuous packs.

FIG. 3 is an external perspective view of a medicine dispensing tray provided with subdivision boxes.

FIG. 4 is an external perspective view of a medicine dispensing tray without subdivision boxes.

FIG. 5A is a vertical sectional view of a cartridge.

FIG. 5B is a bottom view of a cartridge.

FIG. 6A is a front view of a carriage illustrating a schematic configuration or structure of the carriage.

FIG. 6B is a plan view of the carriage of FIG. 6A.

FIG. 7 is a magnified view of a guide groove on a guide unit provided for a carriage.

FIG. 8A, FIG. 8B, FIG. 8C, and FIG. 8D are diagrams illustrating the progression of orientation-changing operations of a suction device.

FIG. 9A, FIG. 9B, and FIG. 9C are front views of a carriage, illustrating the progression of the picking-out operation of the carriage.

FIG. 10A, FIG. 10B, and FIG. 10C are front views of a carriage, illustrating the progression of the picking-out operation of the carriage subsequent to FIG. 9A, FIG. 9B, and FIG. 9C.

FIG. 11 is a flowchart of the picking-out operation of a carriage.

FIG. 12A, FIG. 12B, and FIG. 12C are front views of a carriage, illustrating the progression of the placing operation of the carriage.

FIG. 13 is a diagram illustrating the control blocks of the medication support apparatus of FIG. 1A or FIG. 1B.

FIG. 14 is a flowchart of the sequence of basic operations of the medication support apparatus of FIG. 1A or FIG. 1B.

FIG. 15 is a flowchart of the processes of moving a home position (HP), which is a subroutine program of FIG. 14.

FIG. 16A, FIG. 16B, FIG. 16C, FIG. 16D, FIG. 16E, and FIG. 16F are diagrams illustrating the operation of a carriage to convey a medicine pack from a cartridge to a medicine dispensing tray.

FIG. 17 is a diagram illustrating the control blocks of a medication support system.

FIG. 18A and FIG. 18B are diagrams illustrating the progression of the orientation-changing operations of an orientation changing unit of a suction device, according to a first modification.

FIG. 19A, FIG. 19B, and FIG. 19C are diagrams illustrating an operation according to the first modification.

FIG. 20 is a diagram including a plurality of timing charts according to a second modification, illustrating how and when a carriage is driven to move, a changing operation for the position and orientation of a suction device is performed, and a suctioning operation of the suction device is performed.

FIG. 21 is a diagram including a plurality of timing charts according to a third modification, illustrating how and when a carriage is driven to move, a changing operation for the position and orientation of a suction device is performed, and a suctioning operation of the suction device is performed.

FIG. 22A, FIG. 22B, FIG. 22C, and FIG. 22D are diagrams illustrating the progression of the orientation-changing operations of an orientation changing unit of a suction device, according to the third modification.

FIG. 23A is a diagram illustrating cases in which a medicine pack of large size is sucked and held in a medicine-pack retracting operation (horizontal) suited to regular-sized medicine packs.

FIG. 23B is a diagram illustrating cases in which a medicine pack of large size is sucked and held in a medicine-pack retracting operation (horizontal) suited to medicine packs of large size.

FIG. 24A is a diagram illustrating cases in which a medicine pack of special shape is sucked and held in a medicine-pack retracting operation (horizontal) suited to medicine packs of normal shape.

FIG. 24B is a diagram illustrating cases in which a medicine pack of special shape is sucked and held in a medicine-pack retracting operation (horizontal) suited to medicine packs of special shape.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to limit the present disclosure. As used herein, the singular forms “a”, “an”, and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing embodiments illustrated in the drawings, specific terminology is employed for the sake of clarity. However, the present disclosure is not intended to be limited to the specific terminology so selected and it is to be understood that each specific element includes all technical equivalents that have the same structure, operate in a similar manner, and achieve a similar result.

Embodiments of the present disclosure are described below in detail with reference to the drawings.

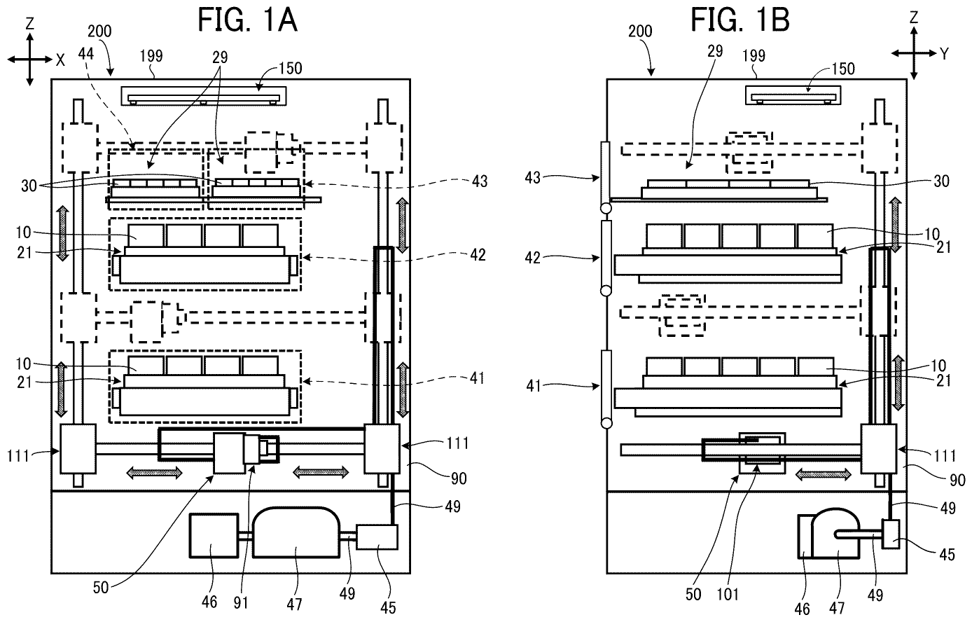

FIG. 1A is a schematic front view of a medication support apparatus in its entirety.

FIG. 1B is a schematic side view of the medication support apparatus 200 of FIG. 1A.

As illustrated in FIG. 1A and FIG. 1B, the medication support apparatus 200 is provided with a cartridge 10 that is an example of a container, a medicine dispensing tray 30 that is an example of a medicine tray, a carriage 50 that is an example of a conveyor, a conveyance unit 90, and a first gate 41 to a fourth gate 44. In FIG. 1A, the side-to-side direction or lateral direction of the medication support apparatus 200 is referred to as an X-axis direction. In FIG. 1B, the front-rear direction or depth direction of the medication support apparatus 200 is referred to as a Y-axis direction. In FIG. 1A and FIG. 1B, the vertical or orthogonal direction of the medication support apparatus 200 is referred to as a Z-axis direction.

Each one of the multiple cartridges 10 serves as a first holder in which a plurality of medicine packages packing a several kinds of medicines are stored upon being stacked on top of each other in layers. The medicine package according to the present embodiment may be referred to simply as a pack or a medicine pack in the following description. The multiple cartridges 10 are arranged at an upper portion and lower portion of a housing 199 of the medication support apparatus 200. The expression “stored upon being stacked on top of each other in layers” in the present disclosure indicates keeping the packs horizontally in such a manner that the front face is viewable.

The multiple cartridges 10 are placed in a pair of drawers 21 arranged at the lowermost portion and middle portion of a housing 199 of the medication support apparatus 200. In the case of the medication support apparatus 200 as illustrated in FIG. 1A and FIG. 1B, twenty cartridges 10 (4×5=20) are placed and held in one of the drawers 21. Each of the pair of drawers 21 serves as a second container in which at least one of the multiple cartridges 10 is placed and held. Each of the multiple cartridges 10 is placed and housed in a partitioned lattice-like side wall and bottom wall in the drawer 21. On the bottom wall of the drawer 21 of corresponding ones of the multiple cartridges 10, a rectangular through opening through which a pack can be picked up from below one of the multiple cartridges 10, making use of the elasticity or free deformation of the pack as will be described later in detail in relation to the operation, is formed.

Each one of the multiple medicine dispensing trays 30 is an example of a medicine tray or medicine dispensing table in which the prescribed packs conveyed by the conveyance unit 90 are arranged. In the present embodiment described with reference to FIG. 1A and FIG. 1B, two medicine dispensing trays 30 each of which has twenty (=4×5) rooms 33 are arranged above the multiple cartridges 10 arranged at an upper portion of the housing 199. The areas that include the medicine dispensing trays 30 where the packs are passed to the medicine dispensing tray 30 for automatic medicine dispensing are referred to as medicine dispensing areas 29 in the following description.

The carriage 50 is provided with a pickup device that picks up a specific pack from a cartridge, and is an example of a conveyor that conveys the medicine pack held by the pickup device. The conveyance unit 90 is an example of a conveying device that conveys the pack picked up from the cartridge 10 by the carriage 50.

Each of the first gate 41 and the second gate 42 is an example of an entrance and exit gate for the container, which allows one of the multiple cartridges 10 to enter and exit the housing 199. The multiple cartridges 10 are inserted and set in the housing 199 through each one of the first gate 41 and the second gate 42. The open and close door of one of the first gate 41 and the second gate 42 are opened, and the drawer 21 in which the multiple cartridges 10 are aligned is drawn out to the front side. By so doing, the cartridges 10 are inserted or withdrawn.

The third gate 43 and the fourth gate 44 are examples of a pair of entrance and exit gates for the medicine dispenser, which allow the multiple medicine dispensing trays 30 that are arranged in two rows at the uppermost stage of the medication support apparatus 200 to enter and exit the housing 199. The third gate 43 and the fourth gate 44 are arranged such that the packs can be picked up immediately after the packs are set or inserted into the medicine dispensing tray 30.

As illustrated in FIG. 1A, the medication support apparatus 200, two medicine dispensing trays 30 are arranged as described above, and as will be described later in detail, the medicine dispensing trays 30 are arranged for each time of medication such as a time in the morning, a time in the daytime, a time in the evening, and a time before going to bed. The third gate 43 and the fourth gate 44 for the medicine dispensing tray 30 are also arranged for each one of the medicine dispensing trays 30. Due to such a configuration, another different one of the medicine dispensing trays 30 can be taken out even when the medicine dispersing operation is performed on a particular one of the multiple medicine dispensing trays 30.

The drawers 21 of the multiple cartridges 10 as illustrated in FIG. 1A and FIG. 1B are collectively arranged in two stages on the upper and lower sides under the medicine dispensing trays 30 at the uppermost stage. However, no limitation is intended thereby, and all the drawers 21 may collectively be arranged on an upper side or may collectively be arranged on a lower side. Depending on the number of persons in the day-care center or nursing home, the cartridges 10 may be arranged in three stages to achieve similar advantageous effects.

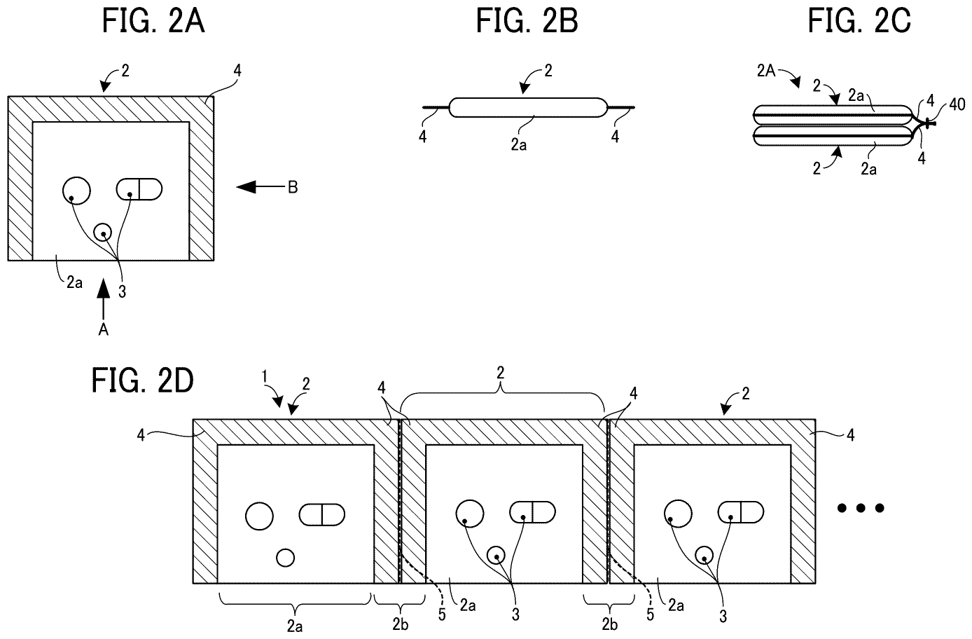

FIG. 2A is a typical plan view of a single medicine package 2.

FIG. 2B a side view of the single medicine package 2 of FIG. 2A viewed in a direction indicated by an arrow A.

FIG. 2C is a side view of bound medicine packages 2A viewed in a direction indicated by an arrow B, where such bound medicine packages 2A are obtained by combining the multiple medicine packages 2.

FIG. 2D is a diagram illustrating a typical form of continuous packs 1.

The medicine pack includes the single medicine package 2 and bound medicine packages 2A in which multiple medicine packages 2 are stacked on top of each other in layers and bound by a staple 40 or the like. In FIG. 2C, two medicine packages 2 are bound as the bound medicine packages 2A.

Except for FIG. 2A, FIG. 2B, FIG. 2C, and FIG. 2D, a single medicine package 2 is illustrated. However, as a matter of course, the bound medicine packages 2A is also included even when only a single medicine package 2 is illustrated. As illustrated in FIG. 2A, one medicine package 2 is formed of, for example, a resin film, and medicines 3 such as capsules or tablets are packed in small quantities. The medicine package 2 includes a bag 2a that covers the medicines 3 and a pressure-bonded portion 4 in which three sides of the bag 2a are pressure-bonded or welded. The pressure-bonded portion 4 is hatched in FIG. 2A and FIG. 2D. Typically, the side of the medicine package 2 on the bag 2a side is folded into two, and the medicines 3 are packed therebetween. The pressure-bonded portion 4 forms a leakage-preventing portion that prevents the medicines 3 from slipping out from the bag 2a. Typically, the medicines 3 in one medicine package 2 is a one-time dosage for a patient who takes medicines.

The medicine package 2 is dispensed and prepared by a drug-dispensing machine installed in, for example, a pharmacy. The dispensing sheets that are used for dispensing the medicines are rolled long-length sheets, and are perforated between packs. The dispensing sheets are rolled in an overlapping manner, and the medicines 3 to be taken are packed in the space between the sheets. The medicines 3 for a required number of doses are divided in small quantities, and packed into the multiple medicine packages 2 that form a continuous sheet. The three sides other than the folded portion of each one of the multiple medicine packages 2 around the medicines 3 for a single dose are sealed in turn by the pressure-bonded portion 4. The multiple medicine packages 2 that form such a continuous sheet may be referred to as continuous packs 1 in the following description. In the continuous packs 1 that are described with reference to FIG. 2D, the multiple medicine packages 2 are coupled to each other and laid like a belt. In the present embodiment described with reference to FIG. 2D, the medicines 3 for three doses are illustrated. The continuous packs 1 are a typical form of drug or medicine that is given or sold at a pharmacy or the like to, for example, a user such as a person who actually takes the medicine 3 in the medicine package 2 and a personal care attendant or assistant who helps or assists the user to take medication, or a staff or the like including a pharmacist, a nurse practitioner, a care manager, or a medication assistant of, for example, various kinds of day-care center, nursing home, or medical institution. For the sake of explanatory convenience, each one of the packs is filled with the medicines 3 of the same form in the following description. In FIG. 2A or FIG. 2D, by way of example, each one of the packs is filled with the same capsule and the same tablets. However, no limitation is indicated thereby. As a matter of course, each one of the packs may be filled with different types of medicines depending on, for example, the usage or purposes of the medication.

In the present embodiment described with reference to FIG. 2A, FIG. 2B, FIG. 2C, and FIG. 2D, the medicine package 2 has a rectangular shape in a plan view, and a packaging method in which three sides are crimped and sealed as in the present embodiment is called three-sided packaging in the related art. Most of the drug-dispensing machines available on the market make packs using the three-sided packaging method.

The pressure-bonded portion 4 has a band-like width of about 10 to 15 millimeters (mm), and has higher rigidity than the portion of the bag 2a that is a transparent or semitransparent film where the medicines 3 can be visually recognized therethrough. A boundary portion 2b that is implemented by perforation 5 is formed in the center of the pressure-bonded portion 4 between a pair of the multiple medicine packages 2 making up the continuous packs 1. The multiple medicine packages 2 are adjacent to each other in an upstream-to-downstream direction. For example, a user who is not handicapped in the hand can obtain one medicine package 2 by tearing off at the perforation 5 by hand or by cutting near the perforation 5 with scissors or a dedicated cutter.

As illustrated in FIG. 2C, the bound medicine packages 2A may be used. The bound medicine packages 2A is formed by fastening medicine packages 2 at the center of the three sides of the pressure-bonded portions 4 by stapling 40 or the like. In FIG. 2C, two medicine packages 2 are fastened together.

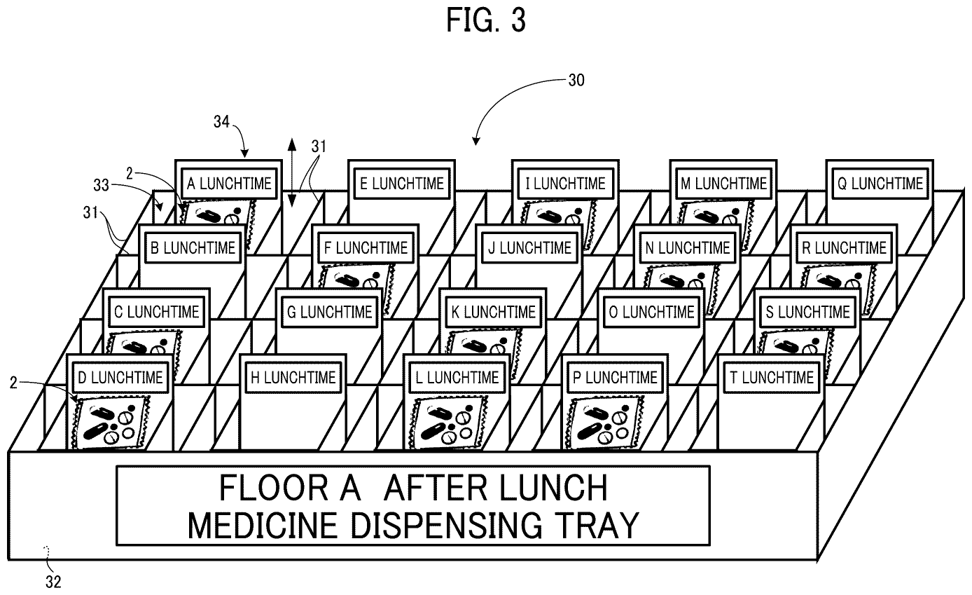

FIG. 3 is an external perspective view of the medicine dispensing tray 30 provided with subdivision boxes 34.

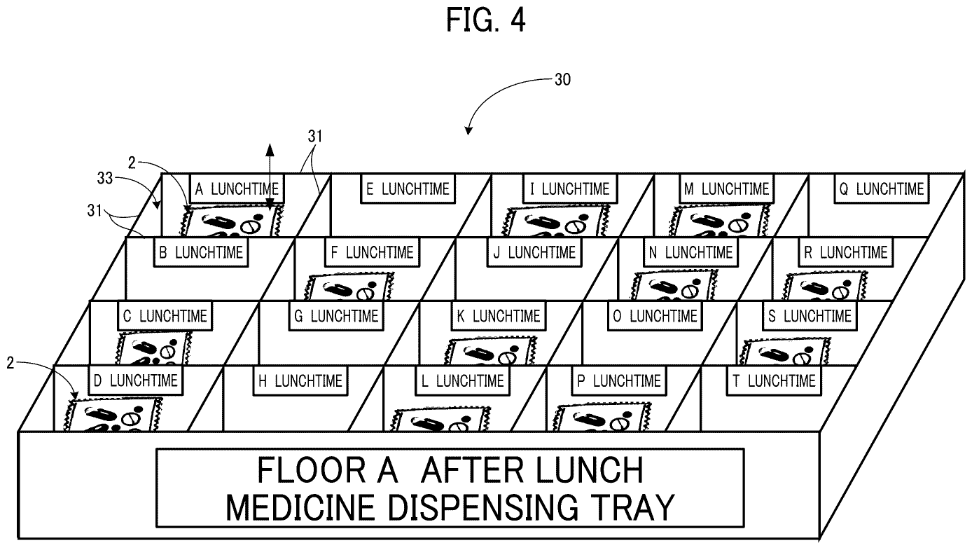

FIG. 4 is an external perspective view of the medicine dispensing tray 30, where prescribed one of the medicine packages 2 is dispensed to desired one of the rooms 33 without involving the subdivision boxes 34.

As illustrated in FIG. 3 and FIG. 4, each one of the multiple medicine dispensing trays 30 has partition walls 31 that serve as a plurality of dividers for arranging prescribed packs, and is partitioned by four upright partition walls 31. The twenty rooms 33 that are formed in each one of the multiple medicine dispensing trays 30 can be expressed as the components of a matrix including five columns in the X-axis direction or the line feed direction and four rows in the Y-axis direction or the character feed direction. As a result, each one of the twenty rooms 33 of the medicine dispensing trays 30 can be uniquely positioned based on the components and addresses of the matrix of five columns and four rows. Furthermore, each one of the multiple medicine dispensing trays 30 has a bottom wall 32 on which the multiple medicine packages 2 are placed. As described above, in the medicine dispensing tray 30, specific one of the multiple packs is placed in specific one of the multiple rooms 33 in a reliable manner by the multiple partition walls 31, which are four partition walls in the present embodiment, and a bottom wall 32 in common, so as not to be mixed up with packs in different one of the multiple rooms 33 or drop off from the bottom wall 32.

FIG. 3 illustrates one of the medicine dispensing trays 30 where a subdivision box 34 attachable to and detachable from each one of the multiple rooms 33 is used, illustrating a state where the medicine dispensing operation is complete after the medicine package 2 is picked up from one of the cartridges 10 and is dispensed to one of the subdivision boxes 34 several times. For example, the multiple subdivision boxes 34 hold the multiple medicine packages 2 filled with the medicines 3 to be taken by twenty residents A to T after lunch in a day-care center or nursing home. In other words, one of the multiple medicine dispensing trays 30 illustrated in FIG. 3 is used to arrange prescribed packs in a predetermined or specific one of the multiple rooms 33 partitioned by dividers through the multiple subdivision boxes 34.

As in the medicine dispensing tray 30 illustrated in FIG. 4, the medicine package 2 may directly be dispensed to one of the rooms 33 of the medicine dispensing tray 30 as long as partitioning is done for each times of medication and occupant. The operation of placing the multiple medicine packages 2 in one of the multiple medicine dispensing trays 30 may be described later with a case in which the multiple subdivision boxes 34 are used.

In each one of the multiple rooms 33 of the multiple medicine dispensing trays 30, a setting position or inserting position is determined for each patient who takes medicines depending on the type of medicines in the pack to be taken. In other words, the multiple rooms 33 in one of the multiple medicine dispensing trays 30 may be allocated to patients who take medicines at the same time. In a case where a specific patient who is to take medicines does not take a medicine at a specific time of medication, the arrangement can be made such that a pack is not given to such a specific patient at the specific time of medication.

However, no limitation is intended by the medicine dispensing trays 30 described above. Each one of the multiple rooms 33 of one of the medicine dispensing trays 30 may be allocated for each time of medication of each patient who takes medicines. More specifically, in such an alternative embodiment of the present disclosure, the multiple rooms 33 may be allocated to each of the patients who take medicines in view of the time of medication of each one of the multiple medicine packages 2 to be taken in the morning, in the daytime, in the evening, or before going to bed. The medicine dispensing trays 30 of such cases may be managed on a room-by-room basis or a floor-by-floor basis in day-care centers or nursing homes where patients who take medicines reside, and the multiple medicine packages 2 for that day or a couple of days may be dispersed in advance to the multiple medicine dispensing trays 30.

According to the above alternative embodiment, allocating the rooms 33 based on each time of medication such as a time in the morning, a time in the daytime, a time in the evening, and a time before going to bed can prevent the time of medication from being mistaken by patients who take medicines. The configuration or structure of the multiple medicine dispensing trays 30 is not limited to the embodiments of the present disclosure described above, and various kinds of combinations are theoretically possible between patients who take medicines and the timing at which the medicines are to be taken. However, such combinations may go beyond the scope of the present disclosure, the description of such combinations is omitted.

Each one of the medicine dispensing trays 30 is identified in a similar manner to the cartridges 10 whose recognition and identification will be described later in detail. The medicine dispensing trays 30 are recognized and identified using, for example, bar codes, QR CODE, and character recognition.

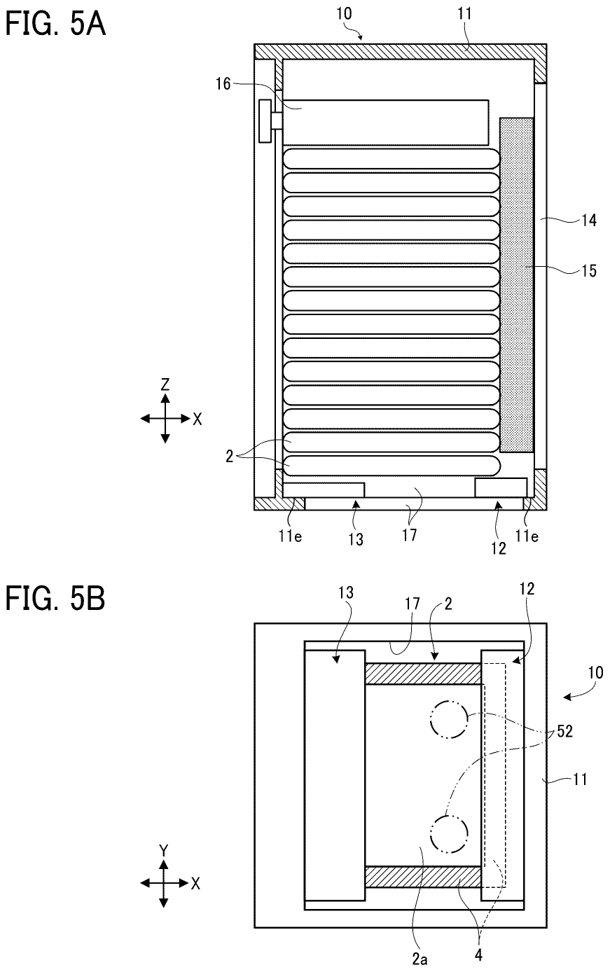

FIG. 5A is a vertical sectional view of the cartridge 10.

FIG. 5B is a bottom view of the cartridge 10 of FIG. 5A.

For the sake of explanatory convenience, in vertical section of FIG. 5A, the multiple medicine packages 2 stored in one of the multiple cartridges 10 are schematically illustrated. For the same purpose, the hatching of the cross sections of the supporters such as the right support portion 12 and the left support portion 13 is also omitted.

For example, each one of the multiple cartridges 10 includes a casing 11, a lid 14, a pack pickup slot 17, a movable board 16, a pack posture keeper 15, and a right support portion 12 and a left support portion 13 each of which serves as a support portion. The casing 11 stores, for example, a plurality of medicine packages 2 or the bound medicine packages 2A. In the following description, a single medicine package 2 will represent such a plurality of medicine packages 2 or bound medicine packages 2A. For example, the casing 11 is integrally or separately formed using resin. The lid 14 enables the multiple medicine packages 2 to be loaded or unloaded. The pack pickup slot 17 is formed in a lower portion or a bottom portion of the casing 11, and is used to pick up the medicine package 2 in one of the multiple cartridges 10. Moreover, the pack pickup slot 17 allows the medicine package 2, which is picked up from one of the multiple cartridges 10 by the carriage 50 (see, for example, FIG. 1A and FIG. 1B), to pass therethrough.

The movable board 16 prevents the medicine package 2 from falling out, and moves the lowermost one of the medicine packages 2 to a position close to the pack pickup slot 17 after the first one of the maximum number of medicine packages 2 that can be stored in the casing 11 is picked up. The pack posture keeper 15 keeps the posture of the medicine package 2. The right support portion 12 and the left support portion 13 also support or hold the medicine package 2 in the casing 11.

In the present embodiment, the to-be-picked-up portion of one of the multiple medicine packages 2 to be picked up from one of the multiple cartridges 10 by the carriage 50 is at a lower portion or bottom portion of the corresponding one of the multiple cartridges 10. In other words, the to-be-picked-up portion includes the pack pickup slot 17, and the right support portion 12 and the left support portion 13 that serve as a pair of support portions or supporting member and support, at multiple points, one of the multiple medicine packages 2 to be picked up from one of the multiple cartridges 10.

When one of the multiple medicine packages 2 is picked up from one of the multiple cartridges 10 by the carriage 50, the right support portion 12 and the left support portion 13 allow one of the multiple medicine packages 2 to pass through. On the other hand, when any one of the multiple medicine packages 2 is not to be picked up from one of the multiple cartridges 10, the right support portion 12 and the left support portion 13 restrict the passage of one of the multiple medicine packages 2 to store and hold the multiple medicine packages 2 in the casing 11.

As described above, the right support portion 12 and the left support portion 13 support or hold the medicine packages 2 in the cartridge 10, and each one of the right support portion 12 and the left support portion 13 is fixed and immovable such that one of the multiple medicine packages 2 can be picked up in a stable manner from one of the multiple cartridges 10 by the carriage 50. The right support portion 12 and the left support portion 13 are a pair of fixation members that are fixed or attached to a pair of bottom-wall inner surfaces 11e of the right bottom-wall edge and left bottom-wall edge of the pack pickup slot 17, respectively. As illustrated in FIG. 5B, the pack pickup slot 17 has a function to allow the pair of suction pads 52 of the carriage 50, each of which serves as an air suction unit or suction unit, to pass therethrough in order to pick up one of the multiple medicine packages 2, and has a function to let the medicine package 2 that is picked up and the pair of suction pads 52 to pass through.

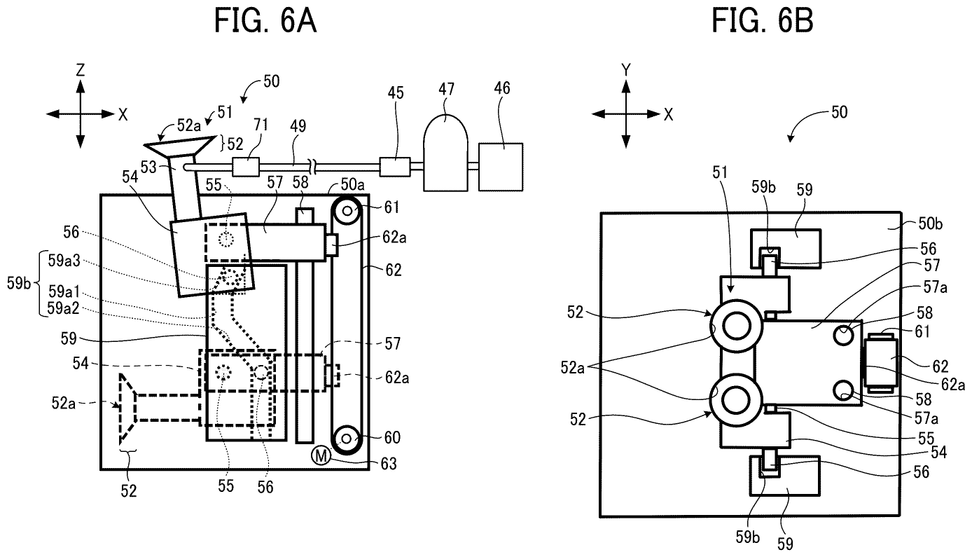

In one of the multiple cartridges 10 illustrated in FIG. 5B, a pair of positions at which the pair of suction pads 52 adsorb or suck up one of the multiple medicine packages 2 stored in one of the multiple cartridges 10, as will be described later in detail, are indicated by a pair of ring-shaped dot-dot-dash lines as illustrated in FIG. 6B. Such a pair of positions may be referred to as a pair of suction pad positions in the following description. The right support portion 12 and the left support portion 13 that are arranged underneath one of the multiple cartridges 10 support the multiple medicine packages 2 in one of the multiple cartridges 10 such that the multiple medicine packages 2 in one of the multiple cartridges 10 do not fall from the pack pickup slot 17. As will be described later in detail in regard to the operation of the carriage 50, when the medicine package 2 at the bottom of the cartridge 10 is sucked and picked up by the pair of suction pads 52, one of the multiple medicine packages 2 is sucked by the pair of suction pads 52 at a pair of suction-pad positions in the Y-axis direction near both ends of the right support portion 12. When the lowermost one of the multiple medicine packages 2 is picked up from one of the multiple cartridges 10 by the pair of suction pads 52, the pair of suction pads 52 passe near both ends of the right support portion 12 in the Y-axis direction to suck and hold one of the multiple medicine packages 2.

As illustrated in FIG. 5B, two points at which the pair of suction pads 52 contact the medicine package are arranged near both ends of the right support portion 12 in the Y-axis direction. Due to such a configuration, the possibility of an error in which the suction by the pair of suction pads 52 is disabled can be avoided and prevented, and the picking up operation can be done successfully. In other words, the medicine package 2 is sucked and adhered to the pair of suction pads 52 at both ends in the Y-axis direction, and the bag 2a of the medicine package 2, which is made of film, is stretched and can withstand the deformation. Accordingly, both reliable support or holding of the multiple medicine packages 2 in one of the multiple cartridges 10 and smooth removal of one of the multiple medicine packages 2 can be achieved.

As illustrated in FIG. 5A, the types of the multiple medicine packages 2 in one of the multiple cartridges 10 are sorted or divided based on the timings at which medicines are taken. For example, one cartridge contains medicines to be taken in fourteen days in the morning by Mr. or Ms. A. In view of the above circumstances, if Mr. or Ms. A takes the medicines not only in the morning but also in the daytime or in the evening, or before going to bed, four cartridges 10 are required in total. However, no limitation is indicated thereby. For example, in an alternative embodiment of the present disclosure, a single cartridge 10 may be prepared for each person or patient who takes medicines. In such cases, for example, a pack to be used in the morning on day one, a pack to be used at lunchtime on day one, a pack to be used in the evening on day one, a pack to be used before going to bed on day one, a pack to be used in the morning on day two, a pack to be used at lunchtime on day two, and a pack to be used in the evening on day two may be stored in the order listed upward from the pack pickup slot 17 parallel to the direction in which packs are taken out from the multiple cartridges 10.

In the present embodiment, the right support portion 12 and the left support portion 13 are fixed to the bottom-wall inner surface 11e of the pack pickup slot 17 of the casing 11 such that one of the multiple medicine packages 2 can be picked up in a stable manner from one of the multiple cartridges 10 by the carriage 50. In other words, the right support portion 12 and the left support portion 13 are fixed when the right support portion 12 and the left support portion 13 hold both ends of the medicine pack such as the medicine package 2 or the bound medicine packages 2A around the pack pickup slot 17 arranged at the lower portion of one of the multiple cartridges 10.

An end of the bottom one of the multiple medicine packages 2 to be adsorbed by, for example, an adsorption system, is supported by the right support portion 12, and the other end of the bottom one of the multiple medicine packages 2 is supported by the left support portion 13. Due to such a configuration, the medicine packages 2 that are set and stored in the cartridge 10 do not drop. The right support portion 12 and the left support portion 13 are different in the length of the portion that supports the multiple medicine packages 2, and the length of the portion of the right support portion 12 that supports the multiple medicine packages 2 is shorter than that of the left support portion 13. As will be described later in detail with reference to FIG. 6A and FIG. 6B, when the lowermost one of the multiple medicine packages 2 stored in the cartridge 10 is adsorbed or sucked by the pair of suction pads 52 and is pulled out from the cartridge 10, the medicine pack is bent due to its elasticity. Accordingly, the medicine pack can easily be pulled out.

In such a configuration, the pair of support portions including the right support portion 12 and the left support portion 13 are of a fixed type. Accordingly, the front end of the next one of the multiple medicine packages 2 to be taken out can be reliably held and does not jump out or fall off together with one of the multiple medicine packages 2 that is being taken out. As the pair of support portions including the right support portion 12 and the left support portion 13 do not swing or rotate, the medicine package 2 are held with high stability with no deformation or the like due to unintentional nipping or pressing in the returning operation.

FIG. 6A is a front view of a carriage 50 illustrating a schematic configuration or structure of the carriage 50.

FIG. 6B is a plan view of the carriage of FIG. 6A.

As illustrated in FIG. 6A and FIG. 6B, the carriage 50 includes a suction device 51 that is an example of a holder and suction unit to pick up and holds one of the multiple medicine packages 2 from one of the multiple cartridges 10. The suction device 51 has a function to such up and separate the medicine package 2. When the medicine package 2 is to be sucked up, the suction device 51 has a function to suck up the medicine package 2 using the air under negative pressure generated by the negative-pressure generator 45 that serves as a switching unit between positive pressure and negative pressure. As will be described later in detail, the suction device 51 has a function to separate the medicine package 2 using the pressurized air generated by the negative-pressure generator 45 when the medicine package 2 is to be separated under normal operating conditions.

As illustrated in FIG. 6A, the suction device 51 as described above sucks up one of the multiple medicine packages 2 as the negative-pressure generator 45 transforms the positive pressure generated by an air compressor 46 that serves as an air compressing means into negative pressure. The air compressor 46 is installed outside the conveyance unit 90, and is coupled to the suction device 51 through the air tank 47 and the negative-pressure generator 45 by a member for communication such as an air duct 49.

The air duct 49 is arranged together with, for example, a CABLEVEYOR and a wire harness so as not to be stretched even when the carriage 50 moves inside the medication support apparatus 200. In other words, as illustrated in FIG. 1A and FIG. 1B, the air duct 49 has a one-turn path for each one of the X-axis, the Y-axis, and the Z-axis. Firstly, the air duct 49 is extended from the negative-pressure generator 45 in the Z-axis direction, and makes one turn. Secondly, the air duct 49 is extended in the X-axis direction, and makes one turn. Finally, the air duct 49 is extended in the Y-axis direction and makes one turn, and is coupled to the suction device 51.

The suction device 51 includes a pair of suction pads 52 that suck one of the multiple medicine packages 2, and a suction duct 53 coupled to the pair of suction pads 52. The negative-pressure generator 45 is also called a vacuum ejector valve and communicates with the suction duct 53 through the air duct 49. Each of the pair of suction pads 52 serves as an air suction unit or a suction member that sucks up and picks up one of the multiple medicine packages 2 in one of the multiple cartridges 10. As described above, the upper ends of the pair of suction pads 52 as illustrated in FIG. 6A is arranged to absorb one of the multiple medicine packages 2. The bottom ends of the pair of suction pads 52 as illustrated in FIG. 6A is attached and fixed to the upper end of the suction duct 53 as illustrated in FIG. 6A. The bottom end of the suction duct 53 as illustrated in FIG. 6A is attached and fixed to the suction-pad supporting member 54. A pair of suction pads 52 and suction ducts 53 are arranged in the Y-axis direction.

The carriage 50 is provided with an orientation changing unit used to change the orientation of one of the multiple medicine packages 2 picked up from one of the multiple cartridges 10 to a substantially vertical posture. The orientation changing unit in the carriage 50 includes, for example, a suction-pad supporting member 54 coupled to a suction device base 57 through a rotary shaft 55, a guide unit 59 that is an example of a suction-device guide formed with a guide groove 59b having a specific shape, a guide axis 56 that is fitted into the guide groove 59b of the guide unit 59 to guide the suction-pad supporting member 54, and a suction-device lifting and lowering unit.

The suction-pad supporting member 54 is coupled to the suction device base 57 through the rotary shaft 55. The suction-pad supporting member 54 may rotatably or pivotably be arranged around the rotary shaft 55 fixed to the suction-pad supporting member 54 within a range of a predetermined angle. Alternatively, the suction-pad supporting member 54 may rotatably or pivotably be arranged around the rotary shaft 55 fixed to the suction device base 57. In other words, in FIG. 6A and FIG. 6B, the distance between the center of the rotary shaft 55 and the center of a guide rod 58 in the X-axis direction is kept constant at all times when the suction device base 57 moves along the guide rod 58 in the up and down directions parallel to the Z-axis direction. The guide rod 58 will be described later in detail.

The suction-device lifting and lowering unit includes a pair of guide rods 58 that are arranged in the Y-axis direction to guide the suction device base 57 in the Z-axis direction, an endless belt 62 looped around a driving pulley 60 and a driven pulley 61, and a drive motor 63 coupled to the driving pulley 60 through a driving power conveyor such a gear or a belt. The drive motor 63 is an example of a driver circuit or driving source of the suction-device lifting and lowering unit.

The suction device base 57 is coupled and fixed to the endless belt 62 at a belt grip 62a fixed to the right end of the suction device base 57. A pair of guide rods 58 that extend in the Z-axis direction are arranged in the Y-axis direction, and the bottom ends of those guide rods 58 are fixed to a base frame 50b of a carriage frame 50a provided for the carriage 50. A pair of guiding holes 57a into which the pair of guide rods 58 are inserted are formed around a right end of the suction device base 57. The pulley axis of each one of the driving pulley 60 and the driven pulley 61 is rotatably supported by an immovable member on the carriage frame 50a. The drive motor 63 is fixed to an immovable member provided for the carriage frame 50a of the carriage 50. The drive motor 63 is also a driver circuit to be controlled by the suction-device lifting and lowering unit.

When the suction device base 57 is lifted or lowered by the operation of the drive motor 63, the suction device base 57 is moved along the pair of guide rods 58 in the Z-axis direction. Accordingly, the posture of the suction device base 57 on the XY plane can be kept constant in a substantially horizontal state. The suction-device lifting and lowering unit is not limited to the above-described up-and-down reciprocating mechanism driven by a belt. Alternatively, for example, the suction-device lifting and lowering unit may have a reciprocating linear motion mechanism using a rack and pinion.

A pair of guide units 59 are arranged on both sides of the suction device 51 in the Y-axis direction across the suction-pad supporting member 54, and the bottom end of the guide unit 59 is fixed to the base frame 50b. The guide axis 56 is arranged so as to protrude from both ends of the suction-pad supporting member 54 in the Y-axis direction, and is consistently fitted into the guide groove 59b of the guide unit 59 to guide the suction-pad supporting member 54. As illustrated in FIG. 6A, the guide axis 56 is arranged under the rotary shaft 55 of the suction-pad supporting member 54 in the Z-axis direction, at a certain distance from the rotary shaft 55.

When the suction device base 57 is moved in the Z-axis direction by the operation of the drive motor 63, the guide axis 56 of the suction-pad supporting member 54 is moved in the Z-axis direction parallel to the guide groove 59b having a specific shape while maintaining the posture of the suction device base 57 on the XY plane constant in a substantially horizontal state. Due to such a configuration, the posture of the pair of suction pads 52 can be rotated by approximately 90 degrees. In FIG. 6A, the suction device 51 that is rotated by approximately 90 degrees is indicated by thick broken lines. In the present embodiment, the expression “substantially horizontal state” indicates that the posture of a particular element is within a specific range of tolerance for angle with respect to the horizontal in addition to a state in which the position of a particular element is horizontal.

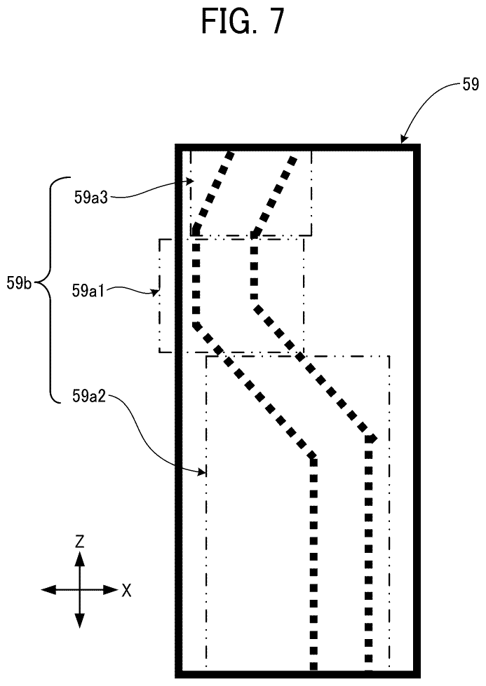

FIG. 7 is a magnified view of the guide groove 59b on the guide unit 59 provided for the carriage 50.

As the guide axis 56 is guided to the first guide groove 59a1, the second guide groove 59a2, and the third guide groove 59a3, the guide grooves 59b each of which has a specific shape and is formed on the guide unit 59 holds the posture of the pair of suction pads 52 in a predetermined direction through the suction-pad supporting member 54 as illustrated in FIG. 6A.

The guide grooves 59b includes the first guide groove 59a1 in which the suction device base 57 can move with approximately horizontal posture when the suction pad 52 moves from its standby position to a pack-sucking position and the second guide groove 59a2 that gradually moves to the right side as it goes downward to rotate the posture of the suction-pad supporting member 54 and the pair of suction pads 52 by approximately 90 degrees, and the first guide groove 59a1 and the second guide groove 59a2 communicate with each other and are coupled to each other. Moreover, the guide grooves 59b includes the third guide groove 59a3 that communicates with and is connected to the top end of the first guide groove 59a1 and gradually moves to the right side as it goes upward to rotate the posture of the suction-pad supporting member 54 and the pair of suction pads 52 to the left.

The first guide groove 59a1 and the second guide groove 59a2 that are formed on the guide unit 59 to change the orientation of the medicine package 2 picked up from the cartridge 10 from an approximately horizontal state in which the direction of the thickness of the medicine package 2 is substantially vertical to a substantially vertical posture is equivalent to orientation changing unit. The guide axis 56 and the third guide groove 59a3 of the guide grooves 59b each of which has a specific shape and is formed on the guide unit 59 make up an angle changing mechanism that changes the angle of the pair of suction pads 52 to a desired direction with respect to the medicine package 2 with the pair of suction pads 52 contacting the medicine package 2 at the bottom of the cartridge 10. The angle changing mechanism controls the pair of suction pads 52 when the pair of suction pads 52 suck one of the medicine packages 2, and makes the pair of suction pads 52 suck up one of the multiple medicine packages 2 in accordance with the inclination of the medicine package 2 at the bottom of the cartridge 10.

As will be described later in detail, when the pair of suction pads 52 rise toward the bottom of the cartridge 10, firstly, the pair of suction pads 52 and their suck-and-hold planes 52a enter the space under the cartridge 10 at an approximately horizontal angle, and then the angle of the pair of suction pads 52 with reference to one of the multiple medicine packages 2 at the bottom is changed depending on the extent to which the pair of suction pads 52 have entered the cartridge 10.

The above angle changing mechanism is provided with a mechanism including a link and slide guide. More specifically, the above angle changing mechanism includes a kind of link, which is a link member of the suction-pad supporting member 54 that guides the suction-pad supporting member 54 and connects the rotary shaft 55 and the guide axis 56 fitted into the guide groove 59b, and a slide guide, which is the guide grooves 59b including the third guide groove 59a3 on the guide unit 59A. The suction-pad supporting member 54 is a driven section coupled to the suction device base 57 that is a drive section and moves upward and downward through the rotary shaft 55.

As illustrated in FIG. 1A, FIG. 1B, and FIG. 6A, the carriage 50 is provided with the suction device 51 that is an example of a holder and uses the air. The carriage 50 is provided with an air tank 47, an air compressor 46, and a negative-pressure generator 45 to perform air suctioning, and those elements are coupled to each other by, for example, the air duct 49 or a joint used for piping. The medication support apparatus 200 can cause vacuum breakdown. The negative-pressure generator 45 generates negative pressure by placing the air under negative pressure using the air compressed by the air compressor 46. By so doing, the pack that contacts the pair of suction pads 52 of the suction device 51 with adhesion can be sucked and kept. Conversely, the held state of the packs can be released by generating pressure using the negative-pressure generator 45 to send out the air to the pair of suction pads 52 of the suction device 51. By so doing, the air discharges at the suck-and-hold planes 52a of the pair of suction pads 52.

Due to the relation between the guide groove 59b and the cross-axis distance between the rotary shaft 55 and the guide axis 56 as described above, the pair of suction pads 52 can take various kinds of posture by moving about the rotary shaft 55 that serves as a fulcrum. For example, the posture of the suction pad 52 can be rotated by approximately 90 degrees.

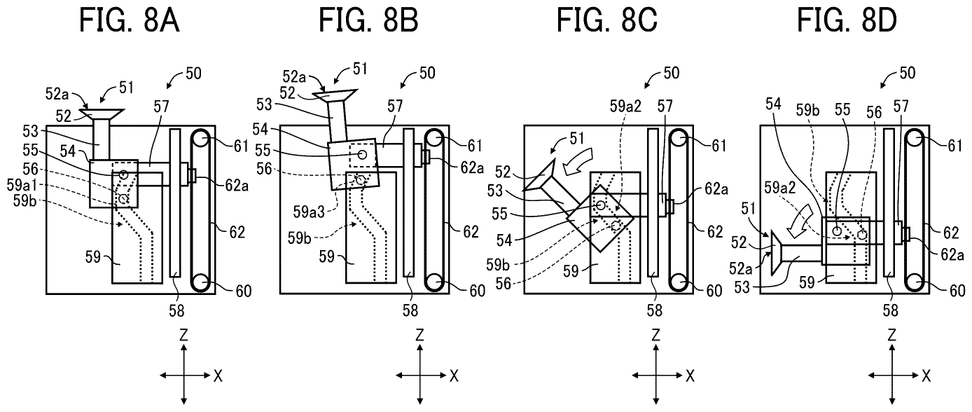

FIG. 8A, FIG. 8B, FIG. 8C, and FIG. 8D are diagrams illustrating the progression of orientation-changing operations of the suction device 51.

As illustrated in FIG. 8A, when one of the medicine packages 2 is picked up from a position below the cartridge 10 illustrated in FIG. 5A, the suction duct 53 of the suction device 51 enters the cartridge 10 with an approximately vertical posture in the upward direction such that the suck-and-hold planes 52a of the pair of suction pads 52 will be approximately horizontal. In so doing, the guide axis 56 moves along the first guide groove 59a1.

Then, as illustrated in FIG. 8B, the endless belt 62 moves upward as the drive motor starts rotating. Accordingly, the suction device base 57 is lifted, and the suction-pad supporting member 54 rises. When the posture of the suction device 51 further changes accordingly, the guide axis 56 moves upward along the third guide groove 59a3, and the pair of suction pads 52 of the suction device 51 are slightly inclined toward the left. With such a posture, the suction device 51 sucks up and picks up a pack from a position below the cartridge 10.

When the pack has been taken out from a position below the cartridge 10 as illustrated in FIG. 8C, the drive motor 63 turns in the reversed manner and the endless belt 62 moves downward. As a result, the suction-pad supporting member 54 rotates on the rotary shaft 55 in a counterclockwise direction of FIG. 8C, around the suction device base 57, while the suction device base 57 is moving downward.

Then, as illustrated in FIG. 8D, the suction device base 57 moves further downward and the suction-pad supporting member 54 rotates around the rotary shaft 55 of the suction device base 57 in a counterclockwise direction of FIG. 8D. Together with the suction device base 57, the guide axis 56 rotates around the rotary shaft 55 in a counterclockwise direction of FIG. 8D while being guided vertically downward along the second guide groove 59a2. The suck-and-hold planes 52a of the pair of suction pads 52 rotate by approximately 90 degrees in a counterclockwise direction from the state illustrated in FIG. 8A, and the rotary shaft 55 and the guide axis 56 are aligned horizontally in a straight line. In so doing, the guide axis 56 moves vertically downward along the second guide groove 59a2 and the suction device 51 rotates by approximately 90 degrees. As the suction holding of the pack is released with this posture, the pack is dispensed to a desired one of the subdivision boxes 34 (see FIG. 3).

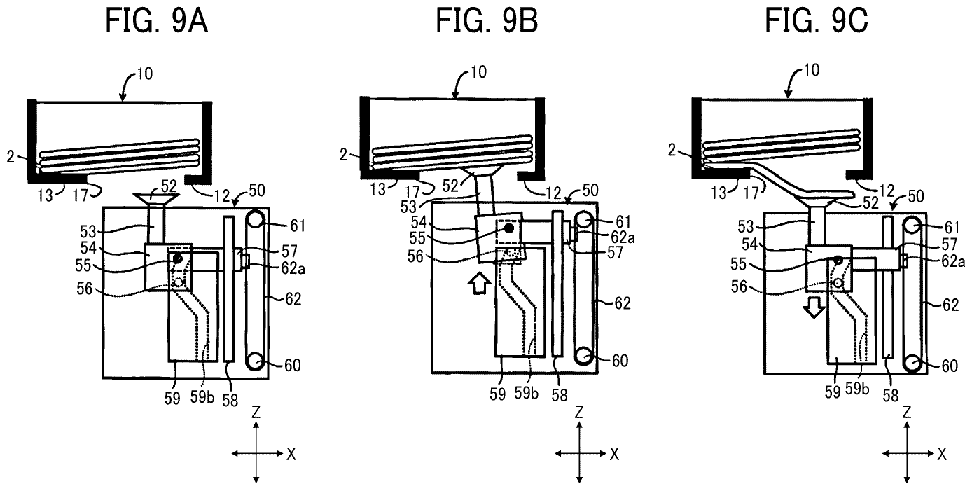

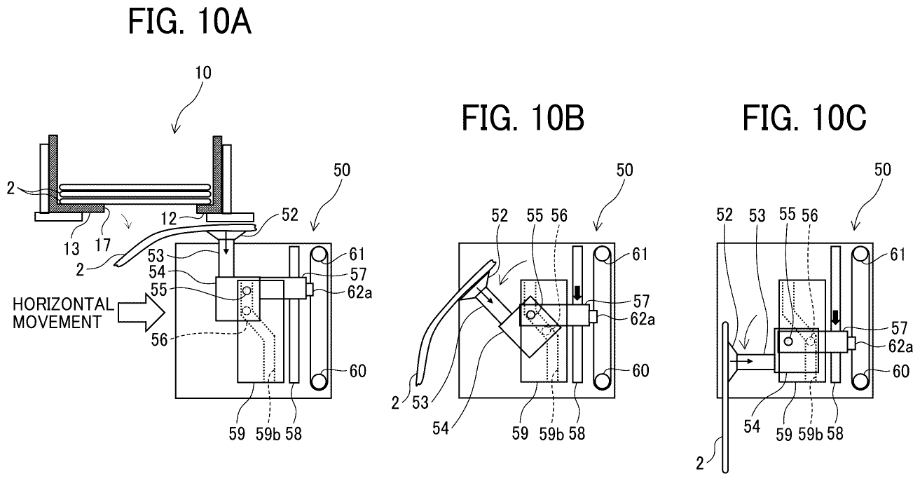

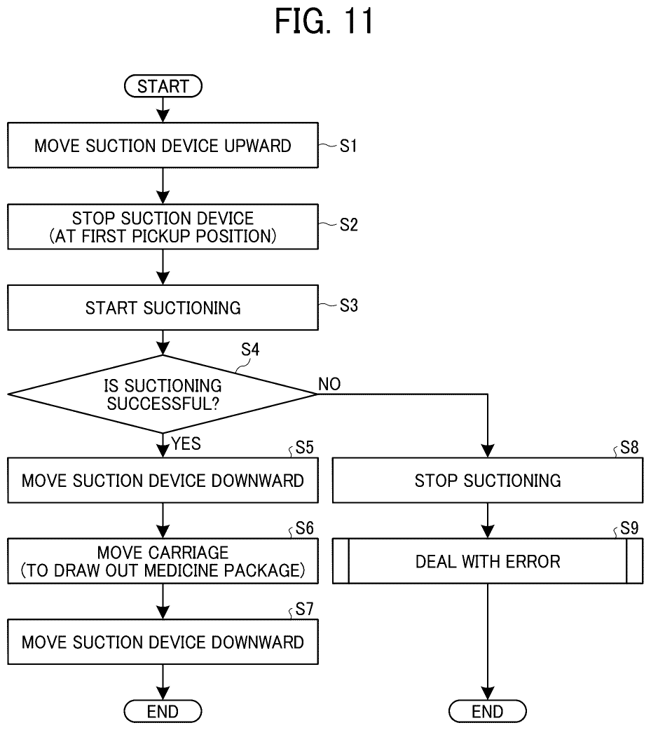

A picking-out operation in which desired one of the multiple medicine packages 2 is picked up from one of the multiple cartridges 10 is described with reference to FIG. 9A to FIG. 10C and the flowchart of FIG. 11.

FIG. 9A to FIG. 10C are front views of the carriage 50, illustrating the series of progression of the operation of the carriage 50.

FIG. 11 is a flowchart of the series of operations of the carriage 50.

For the sake of explanatory convenience, it is assumed in the present embodiment that, due to the operation of the conveyance unit 90 illustrated in FIG. 1A and FIG. 1B, the carriage 50 is arranged below the cartridge 10 provided for one of the drawers 21 arranged at the central portion of the housing 199 illustrated in FIG. 1A and FIG. 1B. After the pair of suction pads 52 of the carriage 50 sucks and pulls out the lowermost pack in the cartridge 10, as the conveyance unit 90 operates, the carriage 50 moves above the medicine dispensing tray 30, which is placed uppermost in FIG. 1A and FIG. 1B. Then, the carriage 50 drops and insert the pack into the subdivision box 34 of specific one of the rooms 33 of the medicine dispensing tray 30.

For the sake of explanatory convenience in relation to the above description with reference to FIG. 6A and FIG. 6B, it is assumed in the present embodiment that the right support portion 12 and the left support portion 13, which are formed at the bottom of the cartridge 10, whose cross sections are indicated by a solid fill in black are made of suitable resin and formed as a single integrated unit. The same applies to the casing 11 of the cartridge 10. For the sake of explanatory convenience, in FIG. 9A to FIG. 10C, the rotary shaft 55 and the guide axis 56 are indicated by a solid line in gray and a broken line, respectively.

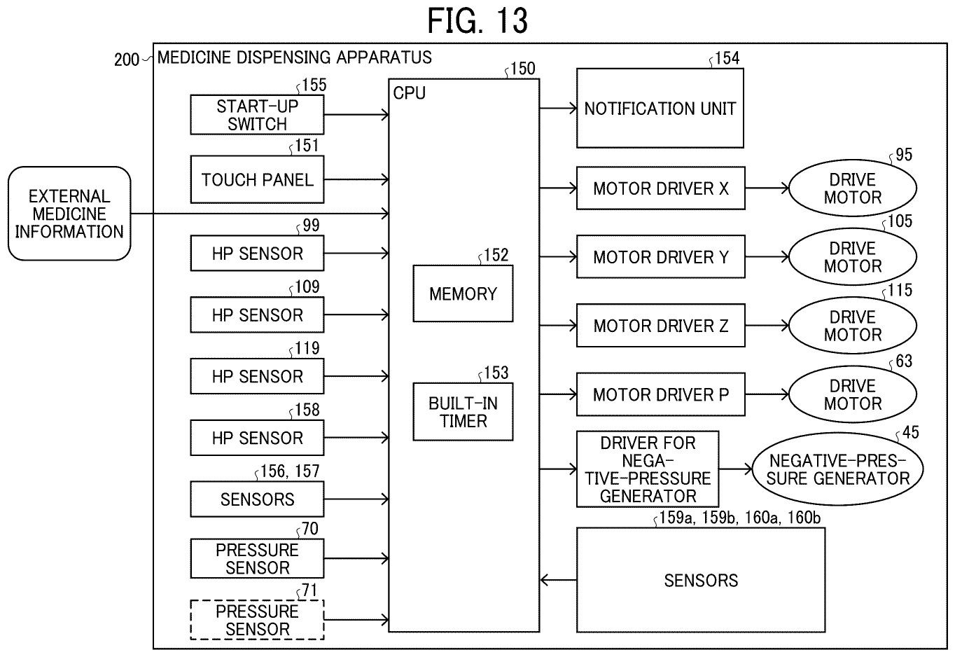

Once the medicine dispensing operation starts, under the control commands from the CPU that is described later in detail in FIG. 13 and makes up the controller 150, the carriage 50 moves to a position under the cartridge 10 by the conveying operation of the conveyance unit 90 illustrated in FIG. 1A and FIG. 1B, stops moving, and goes on standby based on the identification data that is applied to the cartridge 10, in order to pick up desired one of the medicine packages 2. At that moment in time, the drive motor 63 stops its operation, and the suck-and-hold planes 52a of the pair of suction pads 52 takes an approximately vertical or upright posture.

Subsequently, as illustrated in FIG. 9A, the drive motor 63 starts operating, and in step S1, firstly, the suction device base 57 and the pair of suction pads 52 move upward in a straight line through the coupling between the suction device base 57 that linearly moves and the suction-pad supporting member 54 that linearly and rotationally moves. In so doing, the pair of suction pads 52 enter from the pack pickup slot 17 between the right support portion 12 and the left support portion 13 after the suck-and-hold planes 52a of the pair of suction pads 52 changes its posture from an approximately vertical or upright posture to an approximately horizontal posture.

In so doing, in step S2, the drive motor 63 is controlled and stops its operation such that the pair of suction pads 52 of the suction device 51 stop moving at the first pickup position in the posture obliquely inclined toward the left as illustrated in FIG. 8B. When the suction device 51 pauses, the negative-pressure generator 45 (see FIG. 6A and FIG. 6B) is driven to enable sucking operation. As soon as the pair of suction pads 52 contact the medicine package 2, in step S3, as illustrated in FIG. 9B, suctioning on the medicine package 2 starts by the negative pressure generated by the negative-pressure generator 45 illustrated in FIG. 6A.

Subsequently, the process proceeds to step S4, and whether the suctioning is successful is determined. More specifically, whether the negative pressure generated by the negative-pressure generator 45 has an appropriate value to pick up the medicine package 2 from the cartridge 10 by maintaining the negative pressure using the pair of suction pads 52 is checked. As illustrated in FIG. 6A and FIG. 6B, the CPU of the controller 150 determines whether the value detected by the pressure sensor 70 arranged inside the negative-pressure generator 45 or the pressure sensor 71 provided for the air duct 49 between the negative-pressure generator 45 and the pair of suction pads 52 is appropriate.

When whether the sucking of the medicine package 2 by the pair of suction pads 52 is successful is determined as above and it is determined that the suctioning is successful (YES in step S4), in step S5, the suction device 51 moves downward by the reverse operation of the drive motor 63 while maintaining the negative pressure on the medicine package 2 by the pair of suction pads 52 as illustrated in FIG. 9C. The front end of one of the medicine packages 2 is pulled out from one of the multiple cartridges 10. The front end of the medicine package indicates a side of the medicine package to be absorbed or sucked up by the pair of suction pads 52, and the same applies in the following description. The operation of pulling out the front end of one of the multiple medicine packages 2 from the pack pickup slot 17 of one of the multiple cartridges 10 results in sort of free deformation in the pulled-out medicine package 2.

Then, as illustrated in FIG. 10A, in step S6, by the operation of the conveyance unit 90 (see FIG. 1A and FIG. 1B), the carriage 50 is moved in the X-axis direction, which is the lateral or horizontal direction, and the rear end of one of the multiple medicine packages 2 is drawn out or picked up from one of the multiple cartridges 10. Subsequently, in the present embodiment, as the drive motor 63 is driven to rotate, as will be described later in detail, the orientation of one of the multiple medicine packages 2 sucked and held by the pair of suction pads 52 is changed to an orientation as illustrated in FIG. 10B or FIG. 10C where appropriate, while the medicine package 2 is being sucked and held by the pair of suction pads 52. Then, the carriage 50 is moved by the conveyance unit 90 to a position above the subdivision box 34 placed in desired one of the rooms 33 of the medicine dispensing tray 30.

More specifically, when the suction device base 57 moves downward linearly along the guide rod 58 as the drive motor 63 is driven to rotate (see step S7), the guide axis 56 moves along the shape of the guide groove 59b of the guide unit 59, and the relative positions of the rotary shaft 55 and the guide axis 56 change. Accordingly, the orientation of the medicine package 2 can be changed from a substantially horizontal state to, for example, an inclined state as illustrated in FIG. 10B, or can be changed to an approximately vertical or upright posture as illustrated in FIG. 10C. As a result, one of the multiple medicine packages 2 is kept upright such that the thickness direction of that medicine package 2 is substantially horizontal. In other words, the guide axis 56 is moved away from the trajectory followed by the rotary shaft 55 along the shape of the guide groove 59b of the guide unit 59, by the cross-axis distance between the rotary shaft 55 and the guide axis 56, to rotate the pair of suction pads 52 by approximately 45 or 90 degrees. The above series of operations in the above configuration may be achieved by a series of operations performed by a single drive motor 63.

On the other hand, when suctioning of the medicine package 2 by the pair of suction pads 52 is not successful (NO in step S4), in step S8, the generation of negative pressure by the negative-pressure generator 45 and suctioning are stopped, and in step S9, a user such as a nurse practitioner or a care manager deals with an error as specified. Such handling by a user includes, for example, dealing with the medicine package 2 whose pickup from the cartridge 10 was not successful and diagnosing the cause of a problem. Then, this series of processes is terminated.

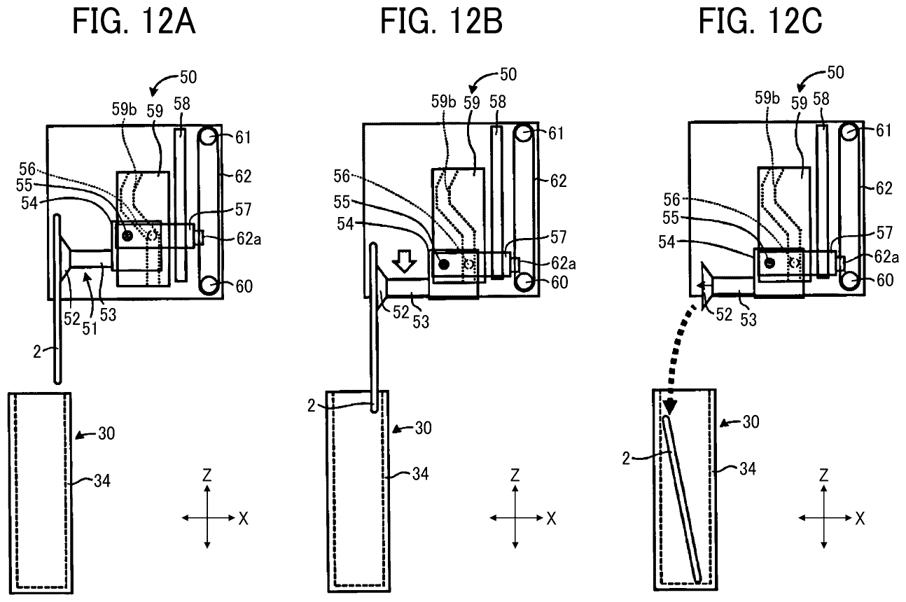

FIG. 12A, FIG. 12B, and FIG. 12C are front views of the carriage 50, illustrating the progression of the placing operation of the carriage 50.

With reference to FIG. 12A, FIG. 12B, and FIG. 12C, a placing operation in which the medicine package 2 is dispensed to a desired one of the subdivision boxes 34 of the medicine dispensing tray 30 is described below. FIG. 12A, FIG. 12B, and FIG. 12C illustrate cases in which the medicine dispensing operation is successfully completed as in, for example, FIG. 3 by a placing operation in which the medicine package 2 is dispensed to a desired one of the subdivision boxes 34 of the medicine dispensing tray 30. However, no limitation is intended thereby, as illustrated in, for example, FIG. 4, the medicine dispensing operation may be completed by a placing operation in which desired one of the medicine packages 2 is dispensed to a desired one of the rooms 33 of the medicine dispensing tray 30 without involving the subdivision boxes 34.

After the above picking-out operation is completed, the carriage 50 is moved by the conveyance unit 90 to a position above the subdivision box 34 placed in desired one of the rooms 33 of the medicine dispensing tray 30 while the medicine package 2 is being sucked and held by the pair of suction pads 52 (see FIG. 12A). During such movement, the position of the carriage 50 in the Z-axis direction and the height direction is designed such that the bottom end of the medicine package 2 held by the pair of suction pads 52 does not contact the subdivision boxes 34.

Subsequently, as illustrated in FIG. 12B, in accordance with the above operation, the bottom edge of the medicine package 2 is inserted into the subdivision box 34 by lowering the suction device base 57, the suction-pad supporting member 54, and the pair of suction pads 52 in its entirety. Accordingly, in the placing operation, the holding of the pack is released after the bottom edge of the medicine package 2 is inserted into the subdivision box 34. Due to such a configuration, the medicine packages 2 is prevented from being dispensed to another one of the subdivision boxes 34 other than desired one of the subdivision boxes when the pack is dropped and rotated or flicked. If the degree of insertion into the subdivision box 34 is small, the bottom edge of the medicine package 2 is caught by the top edge of the subdivision box 34 when the medicine package 2 drops, and there are some cases in which the medicine package 2 is not dispensed to the subdivision box 34. In order to avoid such a situation, it is desired in the picking-out operation that a portion of the medicine package 2 near its top edge be sucked and held to take it out.

As illustrated in FIG. 12A, FIG. 12B, and FIG. 12C, when the negative-pressure generator 45 (see FIG. 6A) is driven to generate positive pressure to send the air to the pair of suction pads 52 for prescribed length of time and the held state of the medicine package 2 is released, the medicine package 2 drops by its own weight. An operation in which the air that is generated by positive pressure is sent out to the pair of suction pads 52 that suck and hold the medicine package 2 by air and the suction holding of the pack is released is referred to as vacuum breakdown in the following description. When the medicine package 2 is stored in the subdivision box 34, it is determined that the medicine dispensing operation or the placing operation is complete and the process proceeds to the next operation.

FIG. 13 is a diagram illustrating the control blocks of a medication support apparatus.

As illustrated in FIG. 13, the medication support apparatus 200 includes a central processing unit (CPU) that serves as a controller 150 that controls the operation of, for example, the components or elements of the medication support apparatus 200. For example, the CPU may be provided with a built-in memory 152 or a built-in timer 153. The CPU according to the present embodiment may provide notification to, for example, a user including staff or the like at a timing consistent with the program or may instruct the medication support apparatus 200 to perform a particular operation, based on various kinds of input such as the inputs from a sensor as will be described later in detail. To the built-in memory 152, prescription data or medicine information is externally input as external medicine information.

The CPU may have, for example, a computing or control function, and a timer or clocking function. The built-in memory 152 includes, for example, a read-only memory (ROM), a random-access memory (RAM), and an external memory. The ROM according to the present embodiment stores, for example, a program readable by the above CPU and various kinds of data in advance. Such a program stored in the ROM may be a program used in the flowchart of the controlling processes as will be described later in detail. The above various kinds of data may be, for example, the data about the relation between the medicine packages 2 and the rooms 33 or the subdivision boxes 34 of one of the medicine dispensing trays 30 allocated to each of the patients who take medicines, the data about the relation between the medicine packages 2 and the multiple rooms 33 or the multiple subdivision boxes 34 of one of the medicine dispensing trays 30 assigned to each one of the times of medication, or the data about the relation between the medicine packages 2 and the rooms 33 or the subdivision boxes 34 of one of the medicine dispensing trays 30 sorted according to the order in which medicines are to be taken (see, for example, FIG. 3 or FIG. 4).

The CPU has an input and output (I/O) port, and a touch panel 151 that is an example of a user interface (UI) and an operation panel provided with an input unit and a display unit is electrically connected to that input and output port of the CPU. Through the touch panel 151, various kinds of inputs can be made, and for example, the current time, the progress of the storing process of packs, or the stop time are displayed on the touch panel 151. How such inputs are made or the structure or configuration of such a display unit are not limited thereto, and may be, for example, an input unit and a display unit may be arranged separately. Alternatively, a combination of an input device and a display interface such as a combination of a keyboard and a light-emitting diode (LED) display may be adopted.

To the input port of the CPU, a start-up switch 155 that drives the medication support apparatus 200 to operate is electrically connected. Once the start-up switch 155 is touched or pressed down, the medicine dispensing operation to the medicine dispensing trays 30 starts step by step. The medicine dispensing operation to the medicine dispensing trays 30 may start at a time determined in advance by the built-in timer 153.

The CPU according to the present embodiment has an input port, and a medicine dispensing tray sensor 156 that detects the type of medicine dispensing tray 30 stored in the medication support apparatus 200 or determines whether or not there is any medicine dispensing tray 30, and a container sensor 157 that determines whether or not there is any one of the multiple cartridges 10 are electrically connected to the input port of the CPU. As various types of sensors, a pair of container gate opening and closing sensors 159a and 159b that detect the opening and closing of the first gate 41 and the second gate 42 and a pair of medicine dispensing tray gate opening and closing sensors 160a and 160b that detect the opening and closing of the third gate 43 and the fourth gate 44 are electrically connected to the input port of the CPU. The medicine dispensing tray sensor 156, the container sensor 157, the pair of container gate opening and closing sensors 159a and 159b, and the pair of medicine dispensing tray gate opening and closing sensors 160a and 160b are illustrated in FIG. 13.

To the input port of the CPU, an HP sensor 99 for an HP sensor X, which detects the home position (HP) of the X-axis direction conveyance unit 91 in the carriage 50, an HP sensor 109 for an HP sensor Y, which detects the home position (HP) of the Y-axis direction conveyance unit 101 in the carriage 50, and an HP sensor 119 for an HP sensor Z, which detects the home position (HP) of the Z-axis direction conveyance unit 111 of the carriage 50 are electrically connected. Further, to the input port of the CPU, a home position (HP) sensor 158 for an HP sensor P, which detects the home positions (HP) of the pair of suction pads 52 of the suction device 51 in the carriage 50 is electrically connected. Further, to the input port of the CPU, the pressure sensor 70 or the pressure sensor 71 that detects the pressure inside the negative-pressure generator 45 or the carriage 50 is electrically connected.

To the output port of the above CPU, the drive motor 95 for the X-axis direction conveyance unit 91, the drive motor 105 for the Y-axis direction conveyance unit 101, the drive motor 115 for the Z-axis direction conveyance unit 111, and the drive motor 63 used to change the orientation of the pair of suction pads 52 are electrically connected to the input port of the CPU through various kinds of motor drivers X, Y, Z, and P, respectively. Moreover, to the output port of the above CPU, the negative-pressure generator 45 that is an example as an ejector valve and an actuator used for the negative-pressure generator is electrically connected through a driver used for a negative-pressure generator. To the output port of the CPU, a notification unit may be electrically connected. Such a notification unit reports what sort of state or conditions the components or elements of the medication support apparatus 200 are in by means of, for example, the light emitted from a light-emitting diode (LED) and the sound or vibration including voice. Moreover, such a notification unit may be provided with, for example, a loudspeaker or a light that indicates that the medicines are to be taken so that the staff or the like away from the medication support apparatus 200 can be notified of such a time of medication.

The external medicine information is also input to the CPU through an input and output (I/O) interface, and is stored in the built-in memory 152. For example, the external medicine information is used for the allocation of medicines to patients who take medicines. For example, the LEDs of the drawer 21 may be electrically connected to each other.

Once the input data from the touch panel 151 and various kinds of signals from various types of sensors or the HP sensors 99, 109, 119, and 158 are input to the CPU, a command signal is newly output from the CPU. In other words, the CPU according to the present embodiment outputs a command signal used to control the audio device or the optical device of the display device of the touch panel 151 including the above notification unit, the LEDs 25a1 to 25d5, the drive motor 63, the drive motor 95, the drive motor 105, the drive motor 115, or the multiple drives that correspond to the multiple LEDs.

The HP sensor 158 for the HP sensor P and the drive motor 63 that outputs power through the motor driver P are used to control or drive the mechanism for moving the suction device to move upward and downward. The CPU according to the present embodiment has a function to execute various kinds of control operation as will be described later in detail in the following description or the flowchart of the controlling processes.

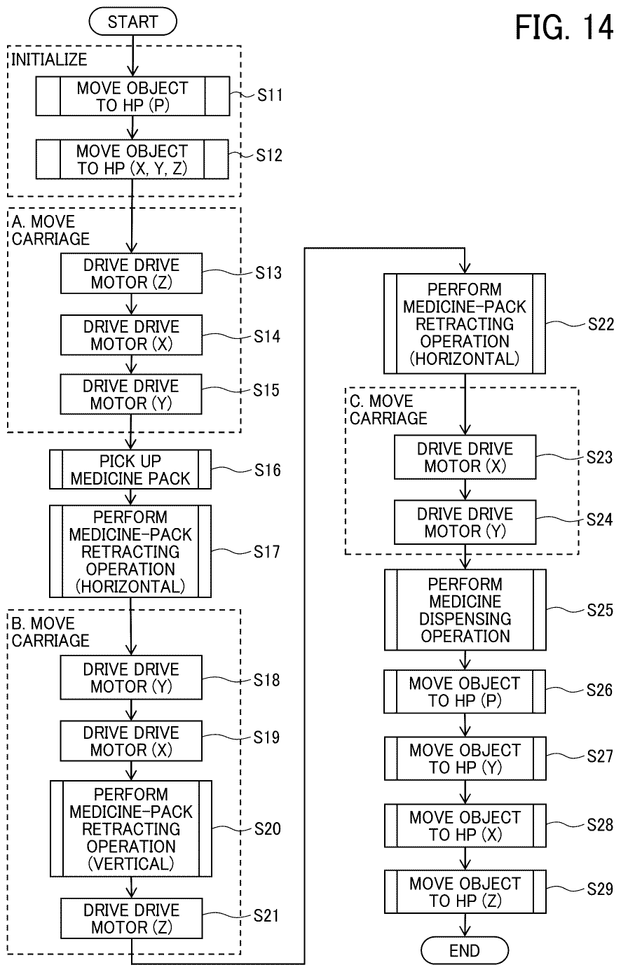

FIG. 14 is a flowchart of the sequence of basic operation of the medication support apparatus 200.

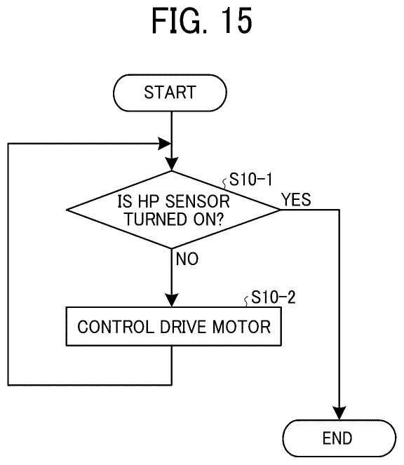

FIG. 15 is a flowchart of the processes of moving the home position (HP), which is a subroutine program of FIG. 14.

The operations in FIG. 14 and FIG. 15 are executed under the control commands from the CPU of the controller 150. When the start-up switch 155 illustrated in FIG. 13 is turned on, the process starts, and in steps S11 and S12, firstly, initialization is performed as illustrated in FIG. 14 (see the initialization part indicated by a frame of broken line in FIG. 14).

In the initialization, the HP sensor and the corresponding drive motor are controlled by the subroutines as depicted in FIG. 15, and an object to be controlled is moved to a predetermined home position (HP) where the HP sensor is turned on (see steps S10-1 to S10-2 in FIG. 15). A series of processes are automatically performed by a built-in timer 153 as depicted in FIG. 13 as follows at prescribed timings that correspond to the medication support operations in the morning, at lunchtime, in the evening, or before going to bed, based on the medicine information that is externally obtained in advance or the input from the touch panel 151 illustrated in FIG. 13.

At predetermined times, in steps S13 to S15, the CPU drives the drive motor 115, the drive motor 95, and the drive motor 105 that correspond to Z, X, and Y, respectively, in the order listed to move the carriage 50 to desired one of the cartridges 10 (see “A. MOVE CARRIAGE” indicated by a frame of broken line in FIG. 14). Subsequently, as a part of the picking-out operation, the drive motor 63 that is used for a drive motor P is driven so that the pair of suction pads 52 are moved close to the medicine package 2 (see FIG. 9B), and the pair of suction pads 52 suck the medicine package 2. Subsequently, in step S16, the drive motor 63 and a drive motor 95 that is used for a drive motor X are operated in cooperation with each other to pick up one of the medicine packages 2 from a position below one of the multiple cartridges 10 (see FIG. 9C and FIG. 10A). Then, one of the multiple medicine packages 2 that has been picked up from one of the multiple cartridges 10 is conveyed by the carriage 50 to the medicine dispensing tray 30 while being sucked and held by the pair of suction pads 52.

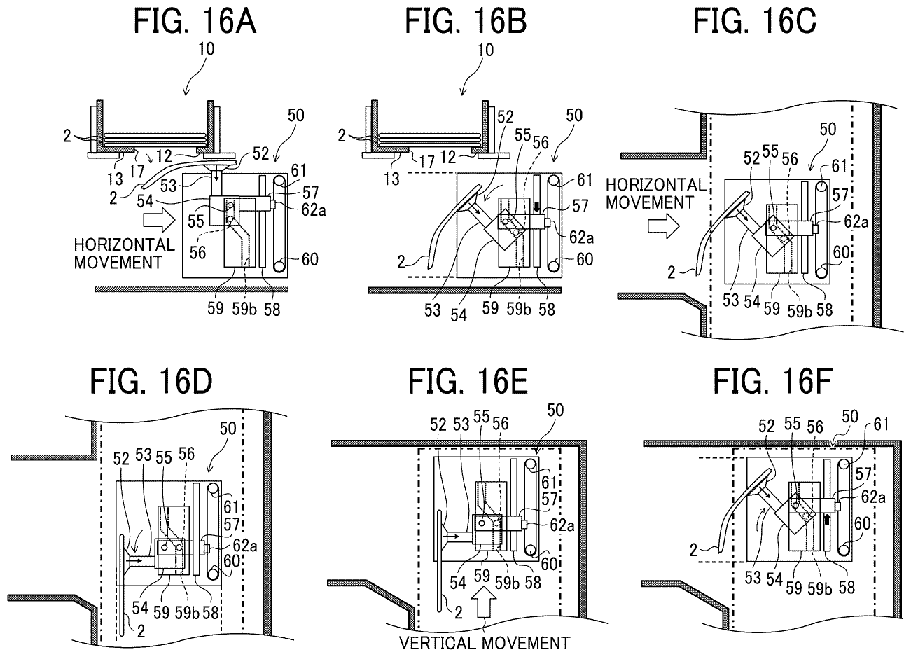

FIG. 16A, FIG. 16B, FIG. 16C, FIG. 16D, FIG. 16E, and FIG. 16F are diagrams illustrating the operation of the carriage 50 to convey the medicine package 2 from the cartridge 10 to the medicine dispensing tray 30.

As illustrated in FIG. 16A, after desired one of the multiple medicine packages 2 is picked up from the cartridge 10, the CPU of the controller 150 drives the drive motor 63 to rotate to move the suction device base 57 downward along the guide rod 58. Accordingly, the guide axis 56 moves along the shape of the guide groove 59b of the guide unit 59. Then, in step S17, the orientation of the pair of suction pads 52 changes, and the orientation of one of the multiple medicine packages 2 sucked and held by the pair of suction pads 52 is changed from a substantially horizontal state to an inclined state as illustrated in FIG. 16B (see also FIG. 10B).

As a result, as illustrated in FIG. 16A, the medicine package 2 that used to be protruding to a space above the carriage 50 changes its orientation so as not to protrude to that space above the carriage 50. Accordingly, when the carriage 50 is then to move along a horizontal path inside the medication support apparatus 200, which is an example of the movement path, in the horizontal direction parallel to the X-axis direction and the Y-axis direction, the medicine package 2 can avoid getting caught by, for example, various kinds of components arranged at an upper portion of the horizontal path.

On the other hand, when the orientation of one of the multiple medicine packages 2, which is sucked and held by the pair of suction pads 52, is changed under such circumstances from a substantially horizontal state to a substantially vertical state as illustrated in FIG. 10C, the medicine package 2 may protrude to an area under the carriage 50 in an undesired manner. In such cases, the medicine package 2 may get caught by, for example, various kinds of components arranged at a lower portion of the horizontal path when the carriage 50 is to move along a horizontal path inside the medication support apparatus 200, which is an example of the movement path, in the horizontal direction parallel to the X-axis direction and the Y-axis direction. If a wide path is given in order to avoid getting caught as above, the medication support apparatus 200 tends to increase in size.

In order to avoid such situation, in the present embodiment, when the carriage 50 is to move along a horizontal path inside the medication support apparatus 200, which is an example of the movement path, in the horizontal direction parallel to the X-axis direction and the Y-axis direction, in step S17, as illustrated in FIG. 16B, the CPU of the controller 150 performs a medicine-pack retracting operation (horizontal) in which the orientation of the medicine package 2 is changed to an inclined state as illustrated in FIG. 10B. Due to such a medicine-pack retracting operation (horizontal), the amount of protrusion of the medicine package 2 from the outer edge of the carriage 50 when viewed in the horizontal direction or the moving direction of the carriage 50 can be made smaller than cases in which the orientation of the medicine package 2 is changed to a substantially vertical state as illustrated in FIG. 10C.

As in the present embodiment, it is desired that the orientation or position of the pair of suction pads 52 be determined such that the amount of protrusion of a medicine pack, i.e., the amount of protrusion of a medicine pack from the outer edge of the carriage 50 when viewed in the moving direction of the carriage 50, will be minimized within a range of motion where the pair of suction pads 52 can change their orientation or position. In the present embodiment, when the carriage 50 conveys the medicine package 2 along a horizontal path inside the medication support apparatus 200, the orientation of the medicine package 2 is changed to an inclined state as illustrated in FIG. 16B. By so doing, the height in its entirety, which is the length in the Z-axis direction, including the height of the carriage 50 and the height of the medicine package 2, can be minimized.

By performing such a medicine-pack retracting operation (horizontal) in step S17, the medicine package 2 can avoid getting caught by, for example, various kinds of components arranged at an upper portion or lower portion of the horizontal path when the carriage 50 is to move along a horizontal path inside the medication support apparatus 200, which is an example of the movement path, in the horizontal direction parallel to the X-axis direction and the Y-axis direction, and the medicine package 2 can appropriately be conveyed.

In the medication support apparatus 200, after the medicine package 2 that has been picked up from the cartridge 10 is conveyed by the carriage 50 along the horizontal path, in step S20, the medicine package 2 is directed to the medicine dispensing tray 30 along a vertical path inside the medication support apparatus 200, i.e., a path that extends in the Z-axis direction. At this point, when the orientation of the medicine package 2 is inclined, the medicine package 2 protrudes to a side of the carriage 50 in a lateral direction when viewed in the vertical direction parallel to the Z-axis direction as illustrated in FIG. 16C. For this reason, if the carriage 50 moves along a vertical path inside the medication support apparatus 200, which is an example of the movement path, in the vertical direction parallel to the Z-axis direction with the orientation of the medicine package 2 kept inclined, the medicine package 2 may be caught by, for example, various kinds of components arranged at a side of the vertical path. If a wide path is given in order to avoid getting caught as above, the medication support apparatus 200 tends to increase in size.

In order to avoid such situation, in the present embodiment, when, in step S21, the carriage 50 is to move along a vertical path inside the medication support apparatus 200, which is an example of the movement path, in the vertical direction parallel to the Z-axis direction, in step S20, as illustrated in FIG. 16D, the CPU of the controller 150 performs a medicine-pack retracting operation (vertical) in which the orientation of the medicine package 2 is changed in advance to a substantially vertical state as illustrated in FIG. 10C. Due to such a medicine-pack retracting operation (vertical), the amount of protrusion of the medicine package 2 from the outer edge of the carriage 50 when viewed in the moving direction or vertical direction of the carriage 50 can be made smaller than cases in which the orientation of the medicine package 2 is kept inclined as illustrated in FIG. 10B.

Preferably, as in the present embodiment, it is desired that the orientation or position of the pair of suction pads 52 be determined so as to minimize the amount of protrusion of a medicine pack within a range of motion where the pair of suction pads 52 can change their orientation or position. Due to such a configuration, the amount of protrusion of a medicine pack from the outer edge of the carriage 50 when viewed in the moving direction of the carriage 50 is minimized. In the present embodiment, when the carriage 50 conveys the medicine package 2 along a vertical path inside the medication support apparatus 200, the orientation of the medicine package 2 is changed to a substantially vertical state as illustrated in FIG. 16C. By so doing, the width in its entirety, which is the length in the X-axis direction, including the height of the carriage 50 and the height of the medicine package 2, can be minimized.

By performing such a medicine-pack retracting operation (vertical) in step S20, when the carriage 50 is to move along a vertical path inside the medication support apparatus 200, which is an example of the movement path, in the vertical direction parallel to the Z-axis direction, the medicine package 2 can avoid getting caught by, for example, various kinds of components arranged at a side of the vertical path, and the medicine package 2 can appropriately be conveyed.

Further, in the medication support apparatus 200, after the carriage 50 has conveyed the medicine package 2 along the vertical path in step S23, the medicine package 2 is directed to the medicine dispensing tray 30 along a horizontal path inside the medication support apparatus 200 in step S24. When the orientation of the medicine package 2 is in an approximately vertical state, as described above, the medicine package 2 protrudes to an area under the carriage 50 in an undesired manner when viewed in the horizontal direction parallel to the X-axis direction and the Y-axis direction, and the medicine package 2 may get caught by, for example, various kinds of components arranged at a lower portion of the horizontal path. If a wide path is given in order to avoid getting caught as above, the medication support apparatus 200 tends to increase in size.

In order to avoid such a situation, in the present embodiment, when the carriage 50 moves from a vertical path to a horizontal path inside the medication support apparatus 200 as illustrated in FIG. 16F, in step S22, the CPU of the controller 150 performs a medicine-pack retracting operation (horizontal) in which the orientation of the medicine package 2 is changed from a substantially vertical state as illustrated in FIG. 10C to an inclined state as illustrated in FIG. 10B. Due to such a medicine-pack retracting operation (horizontal), the amount of protrusion of the medicine package 2 from the outer edge of the carriage 50 when viewed in the moving direction or horizontal direction of the carriage 50 can be made smaller than cases in which the orientation of the medicine package 2 is kept substantially vertical as illustrated in FIG. 10C.

Preferably, as in the present embodiment, it is desired that the orientation or position of the pair of suction pads 52 be determined so as to minimize the amount of protrusion of a medicine pack within a range of motion where the pair of suction pads 52 can change their orientation or position. Due to such a configuration, the amount of protrusion of a medicine pack from the outer edge of the carriage 50 when viewed in the moving direction of the carriage 50 is minimized. In the present embodiment, when the carriage 50 conveys the medicine package 2 along a horizontal path inside the medication support apparatus 200, the orientation of the medicine package 2 is changed to an inclined state as illustrated in FIG. 16B. By so doing, the height in its entirety, which is the length in the Z-axis direction, including the height of the carriage 50 and the height of the medicine package 2, can be minimized.

By performing such a medicine-pack retracting operation (horizontal) in step S20, when the carriage 50 is to move along a horizontal path inside the medication support apparatus 200 after passing through a vertical path, the medicine package 2 can avoid getting caught by, for example, various kinds of components arranged at an upper portion or lower portion of the horizontal path, and the medicine package 2 can appropriately be conveyed.

As described above, the carriage 50 is moved to move the medicine package 2 to a position above desired one of the rooms 33 of one of the medicine dispensing trays 30, and then in step S25, a medicine dispensing operation is performed. In the medicine dispensing operation, after the operation of the carriage 50 is terminated, vacuum breakdown is caused. As a result, suctioning is released to separate one of the medicine packages 2 and dispense the separated medicine package to the medicine dispensing tray 30 (see FIG. 12A, FIG. 12B, and FIG. 12C). When the delivery of the medicine packs for a predetermined number of persons is completed after the above operations are performed several times, in step S26 to step S29, the carriage 50 is returned to the home position (HP).

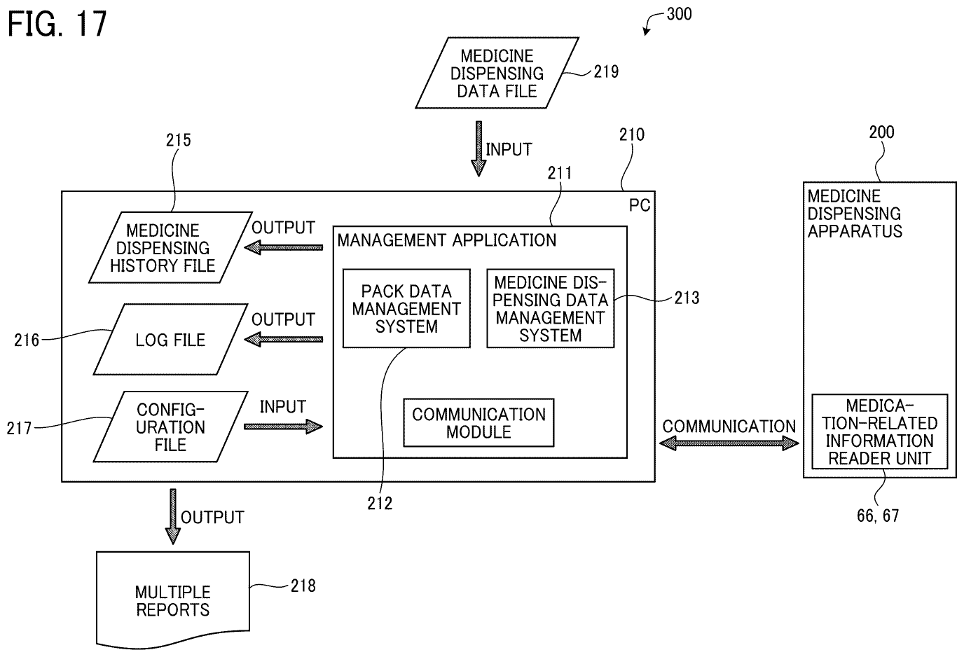

FIG. 17 is a diagram illustrating the control blocks of a medication support system.

As illustrated in FIG. 17, the medication support apparatus 300 is provided with the above-described medication support apparatus 200 and a personal computer (PC) 210 coupled to the medication support apparatus 200. Such coupling enables communication such as data transmission and data reception.

The PC 210 includes five elements known in the art. In other words, the PC 210 is provided with, for example, a control device, a processor, an input device, and an output device. The above control device of the PC 210 is provided with a central processing unit (CPU), and executes a program or gives instructions to other devices. The above processor of the PC 210 executes a program or performs computation. The above memory of the PC 210 is provided with, for example, a main memory and an auxiliary memory, and stores data such as programs or texts. The above input device of the PC 210 includes, for example, a mouse, a keyboard, a microphone, and sends data or instructions to the computer. The above output device of the PC 210 includes, for example, a display, a printer, a loudspeaker, and outputs the data output from the computer.

The PC 210 fulfills the function of the medication support apparatus 200, and serves as a host computer that manages and supports the medication support apparatus 200. The PC 210 is connected to a terminal in a pharmacy or the like at which the medicine is supplied, through the network.

The pack data management system 212 provided for the management application 211 manages the medication-related information of the medicine pack. The medicine-dispensing data management system 213 provided for the management application 211 reads and manages the medicine-dispensing data including at least the name of a patient who takes medicines and the times of medication.

For example, the pack data management system 212 and the medicine-dispensing data management system 213 may be implemented as the management application 211 in the PC 210. As illustrated in FIG. 17, a system may include the medication support apparatus 200 and the PC 210 and performs management by communicating with the medication support apparatus 200. The management application 211 reads the medicine-dispensing data file 219 that is externally produced at a pharmacy or the like where medicines are supplied based on the prescription given by a doctor and includes, for example, times at which medicines are dispensed and medicine information for each patient who takes medicines. The management application 211 reads the data output from the configuration file 217 in which, for example, the setting information once applied to the PC 210 is recorded.

For example, a file to be output as log file 216 according to what has been changed or a medicine dispensing history file 215 in which medicine dispensing history is tracked is the data to be output from the management application 211 as necessary. Further, the multiple reports 218 are output as necessary from the PC 210 through the management application 211. The functions such as of the management application 211 of the PC 210 may be arranged in the medication support apparatus 200.

In the medicine-dispensing data management system 213, the results of medicine dispensing or the change history are stored as record. By so doing, the actual medicine dispensing results are stored as traceability information. This enables a review when a problem occurs.

The pack data management system 212 performs management based on the medication-related information of the medicine pack including at least the name of a patient who takes medicines and the times of medication. However, no limitation is indicated thereby, and a supplementary explanation of the operation of, for example, the medication support apparatus 200 described as above is given below.

The carriage 50 is provided with an upper (quick response) QR code reader 66 and a lower QR code reader 67 in the medication support apparatus 200. The carriage 50 moves close to one of the multiple cartridges 10 that stores a medicine pack such as the medicine package 2 and the bound medicine packages 2A, and the QR CODE that indicates medication-related information can be read by an upper reader unit of the upper QR code reader 66.

### First Modification

A modification of the above-described carriage 50 is described below. The carriage 50 according to the first modification changes the position or orientation of one of the multiple medicine packages 2 sucked and held by the pair of suction pads 52 of the suction device 51 by the rotation of the suction device 51. Overlapping descriptions with the description of the embodiments as described above are omitted where appropriate.

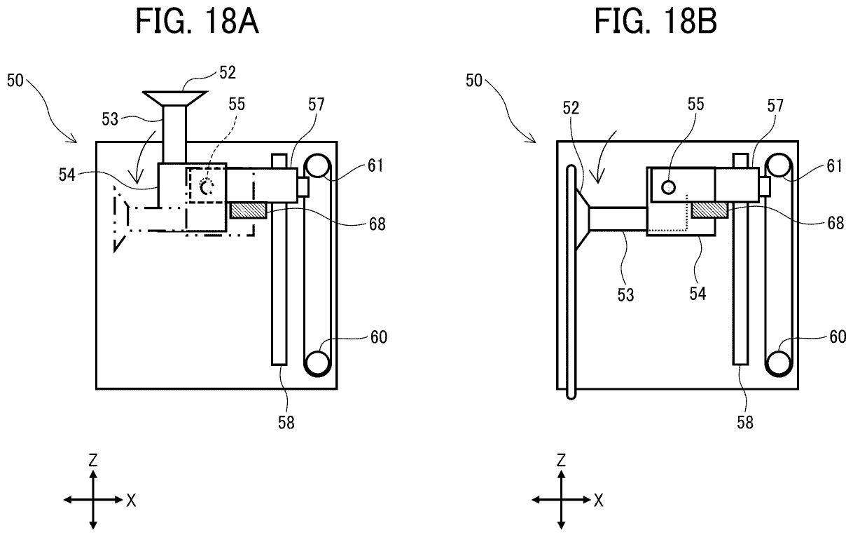

FIG. 18A and FIG. 18B are diagrams illustrating the progression of the orientation-changing operations of the orientation changing unit of the suction device 51.

In the first modification, in place of the guide groove 59b and the guide axis 56, a driver 68 that drives the suction-pad supporting member 54 to rotate around the rotary shaft 55 is provided. The driver 68 is composed of, for example, a solenoid and a motor.

In the first modification, the orientation of the suction device 51 can be changed by the driver 68 to rotate the suction device 51 around the rotary shaft 55 independently from the vertical movement of the suction device 51 by the drive motor 63 in the Z-axis direction. By so doing, the orientation of the suction device 51 can be changed to rotate the suction device 51 around the rotary shaft 55 without moving the suction device 51 vertically in the Z-axis direction, and the position or orientation of the medicine package 2 can be changed.

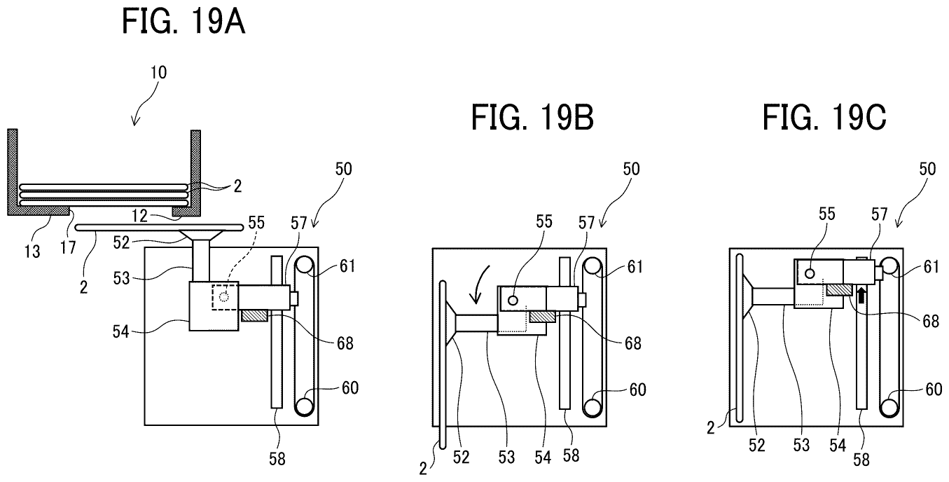

FIG. 19A, FIG. 19B, and FIG. 19C are diagrams illustrating an operation according to the first modification.

As illustrated in FIG. 19A, after desired one of the multiple medicine packages 2 is picked up from the cartridge 10, the CPU of the controller 150 drives the driver 68 to rotate the suction device 51 around the rotary shaft 55. Accordingly, the orientation of the suction device 51 changes, and the orientation of one of the multiple medicine packages 2 sucked and held by the pair of suction pads 52 of the suction device 51 is changed from a substantially horizontal state as illustrated in FIG. 19A to a substantially vertical state as illustrated in FIG. 19B.

However, in the substantially vertical state as illustrated in FIG. 19B, the medicine package 2 protrudes to an area under the carriage 50. In view of these circumstances, in the first modification, the drive motor 63 is driven to rotate to move the suction device base 57 upward. Due to such a configuration, the suction device 51 that is supported by the suction device base 57 moves upward, and as illustrated in FIG. 19C, the medicine package 2 does not protrude to an area under the carriage 50.

In particular, as illustrated in FIG. 19A to FIG. 19C, when the medicine package 2 can completely be retracted and accommodated both in the height direction and the width direction with reference to the outer edge of the carriage 50, a one-time medicine-pack retracting operation is sufficient. In other words, a medicine-pack retracting operation (vertical) and a medicine-pack retracting operation (horizontal) according to the embodiments as described above, where the position or orientation of the medicine package 2 is changed, do not have to be performed repeatedly.

### Second Modification

The operations of the suction device 51 according to the second modification are described below. The suction device 51 according to the second modification changes the position or orientation of the suction device 51. By so doing, the suction force of the suction device 51 on the medicine package 2 increases when the position or orientation of the medicine package 2 is changed. Overlapping descriptions with the description of the embodiments as described above are omitted where appropriate.

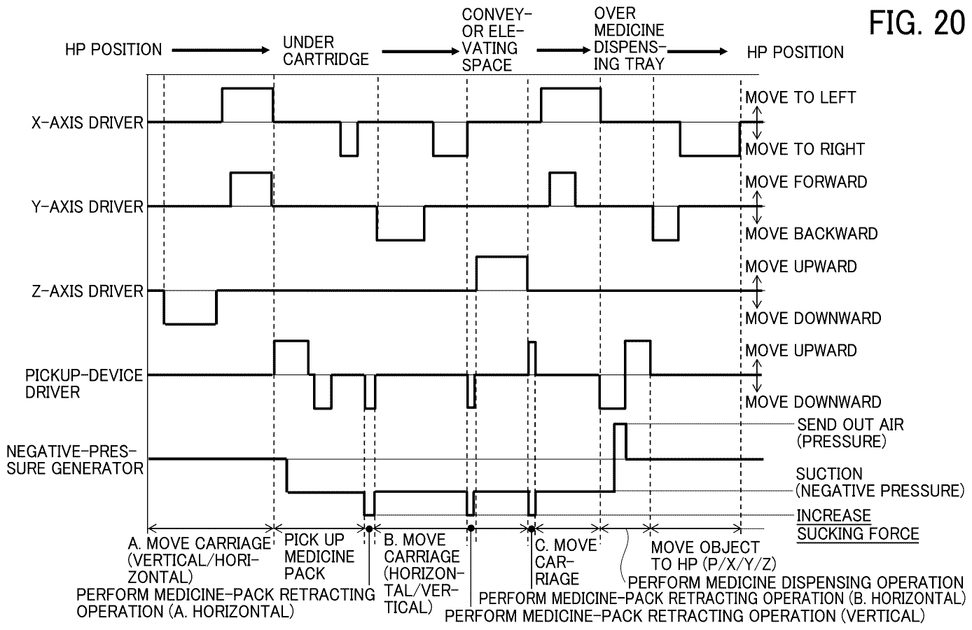

FIG. 20 is a diagram including a plurality of timing charts according to a second modification, illustrating how and when the carriage 50 is driven to move, a changing operation for the position and orientation of the suction device 51 is performed, and a suctioning operation of the suction device 51 is performed.

FIG. 20 illustrates, in the order from top to bottom, the operations of the drive motor 95 for the X-axis direction conveyance unit 91, the drive motor 105 for the Y-axis direction conveyance unit 101, the drive motor 115 for the Z-axis direction conveyance unit 111, the drive motor 63 used to change the orientation of the suction device 51, and the negative-pressure generator 45 used to generate the negative pressure for the suction device 51.

In the second modification, as illustrated in FIG. 20, the negative pressure of the negative-pressure generator 45 is increased to increase the suction force of the medicine package 2 by the pair of suction pads 52 when the first medicine-pack retracting operation (horizontal) is performed (see step S17 in FIG. 14), when a medicine-pack retracting operation (vertical) is performed (see step S20 in FIG. 14), and when the last medicine-pack retracting operation (horizontal) is performed (see step S22 in FIG. 14).

When the position or orientation of the medicine package 2 is changed as in a medicine-pack retracting operation, the medicine pack may drop off from the pair of suction pads 52 due to the inertia of the medicine package 2. In the second modification, also in a medicine-pack retracting operation, the suction force of the medicine package 2 can be increased to prevent the medicine pack from falling off when the position or orientation of the medicine package 2 is to be changed.

When a strong suction force is required in design on a constant basis, the consumption of compressed air increases. In order to handle such a situation, the size of an air tank has to be increased. In the second modification, the suction force is temporarily increased when a medicine-pack retracting operation is performed. Due to such a configuration, the medicine package 2 can be prevented from falling off without increasing the size of an air tank.

### Third Modification

A changing operation for the position or orientation of the medicine package 2 according to a third modification is described below. In the third modification, a changing operation for the position or orientation of the medicine package 2 is performed while the carriage 50 is moving. Overlapping descriptions with the description of the embodiments as described above are omitted where appropriate.

In the above embodiments, in a similar manner to the timing chart of FIG. 20, when the carriage 50 reaches a start position of a vertical path after passing through a horizontal path, the operations of the drive motor 95 for the X-axis direction conveyance unit 91 and the drive motor 105 for the Y-axis direction conveyance unit 101 are terminated. Then, a medicine-pack retracting operation (vertical) is performed before the operation of the drive motor 115 for the Z-axis direction conveyance unit 111 is started and the carriage 50 is moved along the vertical path. The drive motor 63 is driven to rotate to change the position or orientation of the suction device 51, and the medicine package 2 is retracted. For this reason, in the above embodiments, the carriage 50 has to be stopped for the length of time required to perform a medicine-pack retracting operation (vertical).

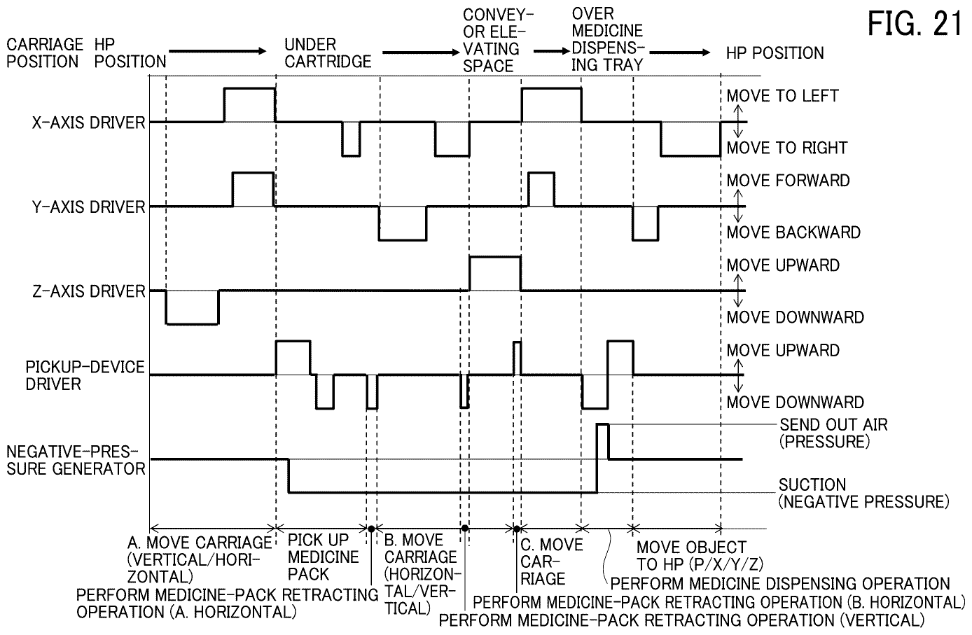

FIG. 21 is a diagram including a plurality of timing charts according to a third modification, illustrating how and when the carriage 50 is driven to move, a changing operation for the position and orientation of the suction device 51 is performed, and a suctioning operation of the suction device 51 is performed.

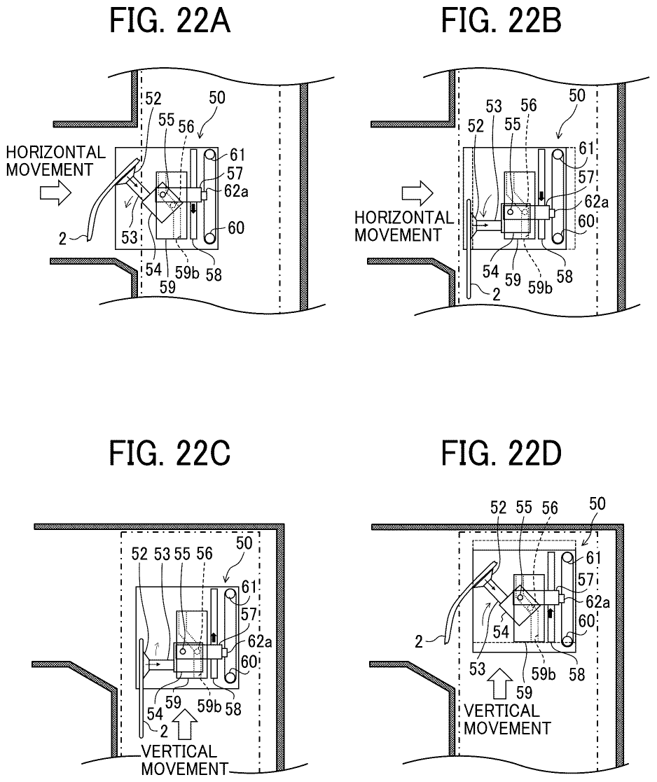

FIG. 22A, FIG. 22B, FIG. 22C, and FIG. 22D are diagrams illustrating the progression of the orientation-changing operations of the orientation changing unit of the suction device 51.

As illustrated in FIG. 22A, in the third modification, a medicine-pack retracting operation (vertical) is started immediately before the carriage 50 reaches a start position of a vertical path after passing through a horizontal path, and the drive motor 63 is driven to rotate to change the position or orientation of the suction device 51. In other words, as illustrated in the timing chart of FIG. 21, a medicine-pack retracting operation (vertical) is started while the drive motor 95 for the X-axis direction conveyance unit 91 is being driven. Accordingly, the length of time to keep the carriage 50 stopped while a medicine-pack retracting operation (vertical) is being performed can be shortened.

As illustrated in FIG. 22B, in the third modification, at substantially the same time as a medicine-pack retracting operation (vertical) has been done or the drive motor 63 is driven to rotate and the position or orientation of the suction device 51 has been changed, the carriage 50 reaches the start position of a vertical path after passing through a horizontal path and the operation of the drive motor 95 for the X-axis direction conveyance unit 91 is terminated. Accordingly, the drive motor 115 for the Z-axis direction conveyance unit 111 can be driven to rotate to move the carriage 50 along the vertical path as soon as the carriage 50 reaches the start position of a vertical path, and the stop time of the carriage 50 is substantially eliminated. Accordingly, the length of time required to move the carriage 50 from the cartridge 10 to the medicine dispensing tray 30 can be shortened, and the productivity of the medication support apparatus 200 can be increased.

As illustrated in FIG. 22C, in the third modification, the final medicine-pack retracting operation (horizontal) is started immediately before the carriage 50 reaches the start position of a horizontal path after passing through a vertical path, and the drive motor 63 is driven to rotate to change the position or orientation of the suction device 51. In other words, as illustrated in the timing chart of FIG. 21, a medicine-pack retracting operation (horizontal) is started while the drive motor 115 for the Z-axis direction conveyance unit 111 is being driven. Accordingly, the length of time to keep the carriage 50 stopped while a medicine-pack retracting operation (horizontal) is being performed can be shortened.

As illustrated in FIG. 22D, in the third modification, at substantially the same time as a medicine-pack retracting operation (horizontal) has been done or the drive motor 63 is driven to rotate and the position or orientation of the suction device 51 has been changed, the carriage 50 reaches the start position of a horizontal path after passing through a vertical path and the operation of the drive motor 115 for the Z-axis direction conveyance unit 111 is terminated. Accordingly, the drive motor 95 for the X-axis direction conveyance unit 91 can be driven to rotate to move the carriage 50 along horizontal path as soon as the carriage 50 reaches the start position of a horizontal path, and the stop time of the carriage 50 is substantially eliminated. As a result, the length of time required to move the carriage 50 from the cartridge 10 to the medicine dispensing tray 30 can be shortened, and the productivity of the medication support apparatus 200 can be increased.

Cases are described below in which an appropriate position or orientation of a medicine pack varies depending on the difference in, for example, the size or shape of the medicine pack.

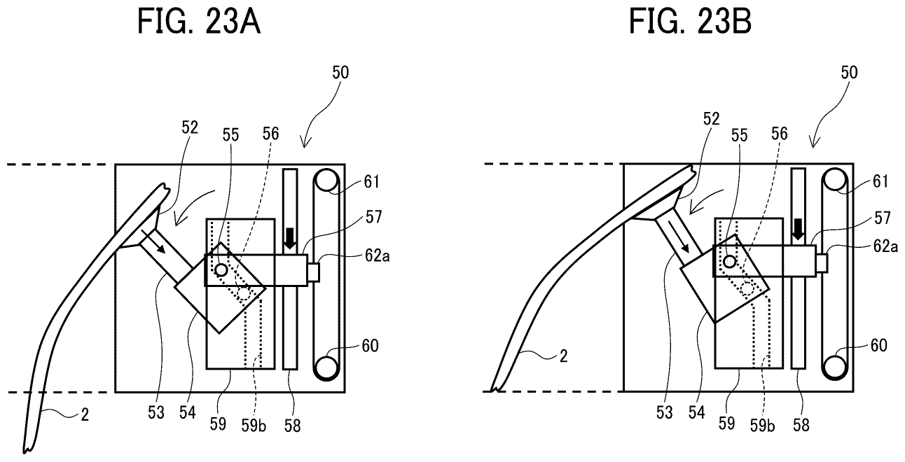

FIG. 23A is a diagram illustrating cases in which the medicine package 2 of large size (instead of regular-sized medicine package) is sucked and held in the above-described medicine-pack retracting operation (horizontal) where the orientation of the suction device 51 is changed and the orientation of the medicine package 2 is inclined.

When the medicine packages 2 are of a regular size, as described above with reference to FIG. 16B or FIG. 16F, the medicine package 2 does not protrude from the outer edge of the carriage 50 when viewed in the moving direction or horizontal direction of the carriage 50. However, when the medicine package 2 of a large size is sucked and held with the same orientation of the suction device 51, as illustrated in FIG. 23A, a portion of the medicine package 2 protrudes to an area under the carriage 50 in an undesired manner.

Even in cases where the medicine package 2 of such a large size is sucked and held, the orientation of the suction device 51 can be made different from the orientation when the medicine package 2 of a regular size is sucked and held. By so doing, as illustrated in FIG. 23B, the amount of protrusion of the medicine package 2 can further be reduced. As described above, the position or orientation of a medicine pack in a medicine-pack retracting operation may be adjusted depending on the difference in the size of the medicine package 2 to be conveyed. By so doing, the amount of protrusion of the medicine package 2 can be minimized depending on the difference in the size of each one of the medicine packages 2, and the medicine packages 2 of any size can be conveyed as desired.

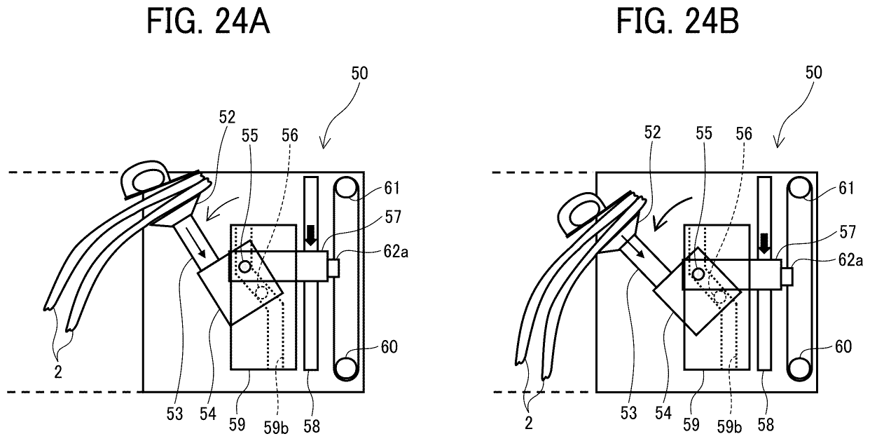

FIG. 24A is a diagram illustrating cases in which the medicine package 2 of a special shape such as coupled medicine packs is sucked and held in the above-described medicine-pack retracting operation (horizontal) where the orientation of the suction device 51 is changed and the orientation of the medicine package 2 is inclined.

When the medicine packages 2 are of a regular shape, as described above with reference to FIG. 16B or FIG. 16F, the medicine package 2 does not protrude from the outer edge of the carriage 50 when viewed in the moving direction or horizontal direction of the carriage 50. However, when the medicine package 2 of a special shape is sucked and held with the same orientation of the suction device 51, as illustrated in FIG. 24A, a portion of the medicine package 2 may protrude to an area over the carriage 50 in an undesired manner.

Even in cases where the medicine package 2 of such a special shape is sucked and held, the orientation of the suction device 51 can be made different from the orientation when the medicine package 2 of a regular shape is sucked and held. By so doing, as illustrated in FIG. 24B, the amount of protrusion of the medicine package 2 can further be reduced. As described above, the position or orientation of a medicine pack in a medicine-pack retracting operation is adjusted depending on the difference in the shape of the medicine package 2 to be conveyed. By so doing, the amount of protrusion of the medicine package 2 can be minimized depending on the difference in the shape of each one of the medicine packages 2, and the medicine packages 2 of any shape can be conveyed as desired.

The embodiments described above are given by way of example, and advantageous effects are achieved for each of the following modes given below.

### First Aspect

A conveying device such as the conveyance unit 90 includes a holder such as the suction device 51 to pick up a medicine pack from a container such as the cartridge 10 that stores a plurality of medicine packs and hold the picked-up medicine pack, and a conveyor such as the carriage 50 to convey the medicine pack held by the holder. The conveying device includes a changer such as a suction-device lifting and lowering unit, which changes a position or orientation of the medicine pack held by the holder, on a movement path of the conveyor such as a horizontal path and a vertical path.

In a conveying device where the medicine pack held by a holder is conveyed by a conveyor, the position or orientation of a medicine pack matters to implement conveyance as desired. In some cases, the position or orientation of a medicine pack becomes inappropriate at a portion of the movement path depending on the movement path of the conveyor. In such cases, sometimes, the medicine pack cannot easily be conveyed appropriately. For example, the medicine pack does not protrude from the outer edge of the conveyor when viewed in a given direction, but the medicine pack may be kept with such a position or orientation that the medicine pack protrudes from the outer edge of the conveyor when viewed in a different direction. Under such an assumption, conveyance can be done appropriately around a portion of the movement path where the conveyor moves in such a given direction, but appropriate conveyance could be difficult as a protruding portion of the medicine pack may get caught by something such as a component existing in a surrounding area, drop off, or be damaged around a portion of the movement path where the conveyor moves in the above different direction.

According to the present aspect, the position or orientation of the medicine pack that is held by the holder can be changed by the changer at some midpoint on the movement path of the conveyor. Due to such a configuration, the position or orientation of a medicine pack can be adjusted to enable appropriate conveyance at any portion of the movement path of the conveyor. Accordingly, a medicine pack can be conveyed as desired throughout a movement path of the conveyor.

### Second Aspect

In the first aspect, the changing unit changes the position or the orientation of the medicine pack when a moving direction of the conveyor is to be changed at on the movement path of the conveyor.

When the moving direction of the conveyor is changed, factors that affect an appropriate conveyance of a medicine pack tend to vary. For example, the degree of how easy the medicine package 2 is released from the holder may vary, and the amount of protrusion of a medicine pack when viewed in the moving direction of the conveyor may vary. According to the present aspect, even when the moving direction of the conveyor is changed as above, the position or orientation of a medicine pack can be adjusted to enable appropriate conveyance. Accordingly, a medicine pack can be conveyed as desired throughout a movement path of the conveyor.

### Third Aspect

According to the first or second aspect, the changing unit changes the position or the orientation of the medicine pack to reduce an amount of protrusion of the medicine pack from an outer edge of the conveyor when viewed in a moving direction of the conveyor.

According to the present aspect, a protruding portion of the medicine pack can be prevented from getting caught by something such as a component existing in a surrounding area, dropping off, or being damaged, and a medicine pack can be conveyed as desired.

### Fourth Aspect

In the third aspect, the changing unit changes the position or the orientation of the medicine pack to minimize the amount of protrusion of the medicine pack.

According to the present aspect, the level of risk that a protruding portion of the medicine pack may get caught by something such as a component existing in a surrounding area, drop off, or be damaged can be minimized, and a medicine pack can be conveyed as desired.

### Fifth Aspect

In any one of the first to fourth aspects, a setting changer to change a setting of the position or the orientation of the medicine pack to be changed by the changer is further provided.

Due to such a configuration, even in cases where an appropriate position or orientation of a medicine pack varies depending on the difference in, for example, the size or shape of the medicine pack, conveyance can be done with an appropriate position or orientation of each medicine pack.

### Sixth Aspect

In any one of the first to fifth aspects, the changing unit changes an orientation of the holder with respect to the conveyor to change the position or the orientation of the medicine pack.

Due to such a configuration, a relatively simple configuration can easily be achieved as compared with cases in which the position of the holder is changed to change the position or orientation of the medicine pack.

### Seventh Aspect

In any one of the first to sixth aspects, the changing unit changes a position of the holder with respect to the conveyor while maintaining an orientation of the holder with respect to the conveyor, to change the position or the orientation of the medicine pack.

Due to such a configuration, the orientation of a holder is maintained, and the held state of the medicine pack by the holder can easily be maintained. Accordingly, a medicine pack does not easily drop off from the holder while the medicine pack is being conveyed by the conveyor.

### Eighth Aspect

In any one of the first to seventh aspects, the holder includes an air suction device such as the suction device 51 to suck and hold the medicine pack, and when the changer changes the position or the orientation of the medicine pack, suction force of the air suction device is increased.

When the position or orientation of the medicine pack is to be changed, the medicine pack may drop off from the holder due to the inertia of the medicine pack. According to the present aspect, the suction force of the air suction device increases when the changer changes the position or orientation of the medicine pack. By so doing, the medicine pack can be prevented from falling off when the position or orientation of the medicine pack is to be changed.

### Ninth Aspect

In any one of the first to eighth aspects, the changing unit changes the position or the orientation of the medicine pack while the conveyor is moving.

Due to such a configuration, the position or orientation of a medicine pack can be changed without stopping the movement of a conveyor. Accordingly, the length of time required to move the conveyor can be shortened as compared with cases in which the position or orientation of the medicine pack is changed with the movement of the conveyor paused.

### Tenth Aspect

In a medication support apparatus such as the medication support apparatus 200, a medicine pack stored in a container is dispensed to a corresponding position of a medicine tray by a conveying device, and the conveying device according to any one of the first aspect to the ninth aspect is used as the conveying device.

According to the present aspect, a medication support apparatus in which a medicine pack is conveyed as desired throughout a movement path of the conveyor can be provided.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Any one of the above-described operations may be performed in various other ways, for example, in an order different from the one described above.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a compact disc-read-only memory (CD-ROM) or digital versatile disk (DVD), and/or the memory of an FPGA or ASIC.

What is claimed is:

1. A conveying device comprising:
a holder to pick up a medicine pack from a container and hold the medicine pack;
a conveyor to convey the medicine pack held by the holder; and
a changer to change a position or orientation of the medicine pack held by the holder, on a movement path of the conveyor.

2. The conveying device according to claim 1,
wherein the changer changes the position or the orientation of the medicine pack when a moving direction of the conveyor is to be changed on the movement path of the conveyor.

3. The conveying device according to claim 1,
wherein the changer changes the position or the orientation of the medicine pack to reduce an amount of protrusion of the medicine pack from an outer edge of the conveyor when viewed in a moving direction of the conveyor.

4. The conveying device according to claim 3,
wherein the changer changes the position or the orientation of the medicine pack to minimize the amount of protrusion of the medicine pack.

5. The conveying device according to claim 1, further comprising
processing circuitry to change a setting of the position or the orientation of the medicine pack to be changed by the changer.

6. The conveying device according to claim 1,
wherein the changer changes an orientation of the holder with respect to the conveyor to change the position or the orientation of the medicine pack.

7. The conveying device according to claim 1,
wherein the changer changes a position of the holder with respect to the conveyor while maintaining an orientation of the holder with respect to the conveyor, to change the position or the orientation of the medicine pack.

8. The conveying device according to claim 1,
wherein the holder includes an air suction device to suck and hold the medicine pack, and
wherein when the changer changes the position or the orientation of the medicine pack, suction force of the air suction device is increased.

9. The conveying device according to claim 1,
wherein the changer changes the position or the orientation of the medicine pack while the conveyor is moving.

10. A medication support apparatus comprising:
a container to store a medicine pack;
a conveying device including
a holder to pick up the medicine pack from the container and hold the medicine pack,
a conveyor to convey the medicine pack held by the holder, and
a changer to change a position or orientation of the medicine pack held by the holder, on a movement path of the conveyor; and
a medicine tray including a desired position to which the medicine pack is conveyed and dispensed by the conveying device.
